(19) United States
(12) Patent Application Publication
(10) Pub. No.: US 2009/0150331 A1
(43) Pub. Date: Jun. 11, 2009

(54) Method and system for creating reports

(75) Inventors: Schuyler Buck, Muncie, IN (US); Morris J. Young, Indianapolis, IN (US); Ryan Scott McKinney, Jamestown, IN (US)

Correspondence Address: BAKER & DANIELS LLP / ROCHE, 300 NORTH MERIDIAN STREET, SUITE 2700, INDIANAPOLIS, IN, 46204, US

(73) Assignee: Roche Diagnostics Operations, Inc., Indianapolis, IN (US)

(21) Appl. No.: 11/999,851

(22) Filed: Dec. 7, 2007

(51) Int. Cl. G06F 17/30

(52) U.S. Cl. 707/1; 707/E17.001

(57) ABSTRACT

A system and method for reporting medical information permits a user to produce reports by storing report templates in a database, selecting at least two of the report templates and storing the selected report templates in the database as a new report template. The user can also change parameters associate with the previously stored report templates when creating the new report template.

### FIELD OF THE INVENTION

The present invention relates to systems and methods for reporting medical information. In particular, the present invention relates to systems and methods for generating customized reports and letters and for distributing the reports and letters by fax, e-mail, mail and other means. Concepts described below may be further explained in one of more of the co-filed patent applications entitled HELP UTILITY FUNCTIONALITY AND ARCHITECTURE (Atty Docket: ROCHE-P0033), METHOD AND SYSTEM FOR GRAPHICALLY INDICATING MULTIPLE DATA VALUES (Atty Docket: ROCHE-P0039), SYSTEM AND METHOD FOR DATABASE INTEGRITY CHECKING (Atty Docket: ROCHE-P0056), METHOD AND SYSTEM FOR DATA SOURCE AND MODIFICATION TRACKING (Atty Docket: ROCHE-P0037), PATIENT-CENTRIC HEALTHCARE INFORMATION MAINTENANCE (Atty Docket: ROCHE-P0043), EXPORT FILE WITH MANIFEST FOR ENHANCED DATA TRANSFER (Atty Docket: ROCHE-P0044), GRAPHIC ZOOM FUNCTIONALITY FOR A CUSTOM REPORT (Atty Docket: ROCHE-P0048), METHOD AND SYSTEM FOR SELECTIVE MERGING OF PATIENT DATA (Atty Docket: ROCHE-P0065), METHOD AND SYSTEM FOR PERSONAL MEDICAL DATA DATABASE MERGING (Atty Docket: ROCHE-P0066), METHOD AND SYSTEM FOR WIRELESS DEVICE COMMUNICATION (Atty Docket: ROCHE-P0034), METHOD AND SYSTEM FOR SETTING TIME BLOCKS (Atty Docket: ROCHE-P0054), METHOD AND SYSTEM FOR ENHANCED DATA TRANSFER (Atty Docket: ROCHE-P0044), COMMON EXTENSIBLE DATA EXCHANGE FORMAT (Atty Docket: ROCHE-P0036), METHOD OF CLONING SERVER INSTALLATION TO A NETWORK CLIENT (Atty Docket: ROCHE-P0035), METHOD AND SYSTEM FOR QUERYING A DATABASE (Atty Docket: ROCHE-P0049), METHOD AND SYSTEM FOR EVENT BASED DATA COMPARISON (Atty Docket: ROCHE-P0050), DYNAMIC COMMUNICATION STACK (Atty Docket: ROCHE-P0051), SYSTEM AND METHOD FOR REPORTING MEDICAL INFORMATION (Atty Docket: ROCHE-P0045), METHOD AND SYSTEM FOR MERGING EXTENSIBLE DATA INTO A DATABASE USING GLOBALLY UNIQUE IDENTIFIERS (Atty Docket: ROCHE-P0052), METHOD AND SYSTEM FOR ACTIVATING FEATURES AND FUNCTIONS OF A CONSOLIDATED SOFTWARE APPLICATION (Atty Docket: ROCHE-P0057), METHOD AND SYSTEM FOR CONFIGURING A CONSOLIDATED SOFTWARE APPLICATION (Atty Docket: ROCHE-P0058), METHOD AND SYSTEM FOR DATA SELECTION AND DISPLAY (Atty Docket: ROCHE-P0011), METHOD AND SYSTEM FOR ASSOCIATING DATABASE CONTENT FOR SECURITY ENHANCEMENT (Atty Docket: ROCHE-P0041), METHOD AND SYSTEM FOR CREATING USER-DEFINED OUTPUTS (Atty Docket: ROCHE-P0047), DATA DRIVEN COMMUNICATION PROTOCOL GRAMMAR (Atty Docket: ROCHE-P0055), HEALTHCARE MANAGEMENT SYSTEM HAVING IMPROVED PRINTING OF DISPLAY SCREEN INFORMATION (Atty Docket: ROCHE-P0031) and METHOD AND SYSTEM FOR MULTI-DEVICE COMMUNICATION (Atty Docket: ROCHE-P0064), the entire disclosures of which are hereby expressly incorporated herein by reference. It should be understood that the concepts described below may relate to diabetes management software systems for tracking and analyzing health data, such as, for example, the ACCU-CHEK®360° product provided by Roche Diagnostics. However, the concepts described herein may also have applicability to apparatuses, methods, systems, and software in fields that are unrelated to healthcare. Furthermore, it should be understood that references in this patent application to devices, meters, monitors, pumps, or related terms are intended to encompass any currently existing or later developed apparatus that includes some or all of the features attributed to the referred to apparatus, including but not limited to the ACCU-CHEK® Active, ACCU-CHEK® Aviva, ACCU-CHEK® Compact, ACCU-CHEK® Compact Plus, ACCU-CHEK® Integra, ACCU-CHEK® Go, ACCU-CHEK® Performa, ACCU-CHEK® Spirit, ACCU-CHEK® D-Tron Plus, and ACCU-CHEK® Voicemate Plus, all provided by Roche Diagnostics or divisions thereof.

### BACKGROUND OF THE INVENTION

Various systems for storing and reporting medical information are known. For example, systems are known which allow a user to download medical data from a device, such as a blood glucose meter, to a database, such as a database stored on a personal computer. In some such systems, the data can be displayed on monitor or printed.

### SUMMARY OF THE INVENTION

In one embodiment of the invention, a method of preparing a report template, includes the steps of storing a plurality of report templates in a database, selecting a first report template and a second report template from the plurality of report templates and storing the first and second report templates in the database as a third report template. Another embodiment of the invention includes the additional steps of selecting a fourth report template from the plurality of report templates and storing the third report template and the fourth report template in the database as a fifth report template. The report templates may include parameters, such as the time period covered by the report templates, that can be changed.

In another embodiment of the invention, the stored report templates are grouped by type of report. These groups of templates may be further divided into different categories.

In another embodiment of the invention, a system for preparing a report template includes a database, a plurality of report templates stored in the database, means for selecting a first report template and a second report template from the plurality of report templates and means for storing the first and second report templates in the database as a third report template. The system may further include means for editing the report templates stored in the database and/or means for assigning a name to the third template.

### BRIEF DESCRIPTION OF THE DRAWINGS

The above-mentioned and other features of this invention, and the manner of attaining them, will become more apparent and the invention itself will be better understood by reference to the following description of embodiments of the invention taken in conjunction with the accompanying drawings, wherein:

FIGS. 1 through 42 depict screen captures of software utilized in connection with embodiments of systems and methods for reporting medical information according to the present invention

Although the drawings represent embodiments of various features and components according to the present invention, the drawings are not necessarily to scale and certain features may be exaggerated in order to better illustrate and explain the present invention. The exemplification set out herein illustrates certain embodiments of the invention, and such exemplification is not to be construed as limiting the scope of the invention in any manner.

### DETAILED DESCRIPTION OF EMBODIMENTS OF THE INVENTION

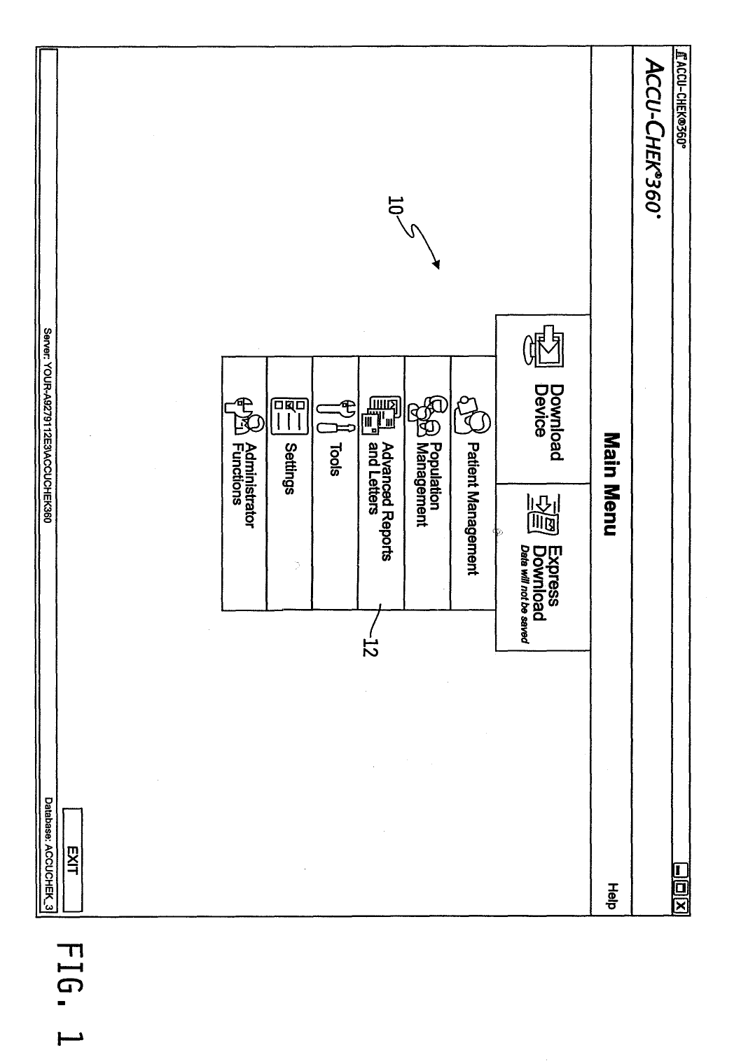

FIG. 1 is a screen capture of the main menu of a system for reporting medical information according to one embodiment of the present invention. As described in greater detail below, the system includes software having a database containing various letter templates, report templates, graphs, charts and data. The software may be installed and run on, for example, a personal computer.

Main menu 10 includes, among other icons, an icon 12 labeled “advanced reports and letters.” The “advanced reports and letters” icon 12 can be selected by utilizing a mouse to position a cursor over icon 12 and clicking. Icon 12 can also be selected in other known manners.

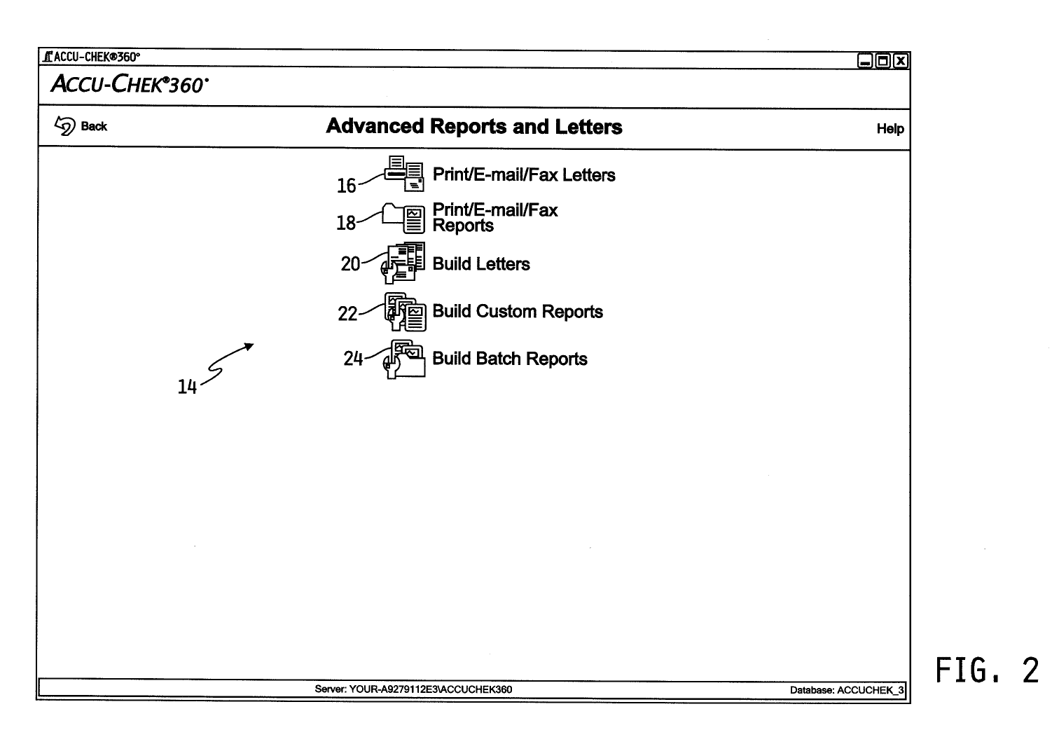

Selecting “advanced reports and letters” icon 12 displays “advanced reports and letters menu” 14 (FIG. 2). Menu 14 includes a “print/e-mail/fax letters” icon 16, a “print/e-mail/fax reports” icon 18, a “build letters” icon 20, a “build custom reports” icon 22 and a “build batch reports” icon 24. The “build letters” icon 20 and the “build custom reports” icon 22 allow the user to construct customized letter and report templates. The “build batch reports” icon 24 allows the user to construct batch reports that are a combination of predefined reports and letters sorted in the system. The “print/e-mail/fax letters” icon 16 and “print/e-mail/fax reports” icon 18 allow the user to send reports via the various means indicated. These features are described in greater detail below.

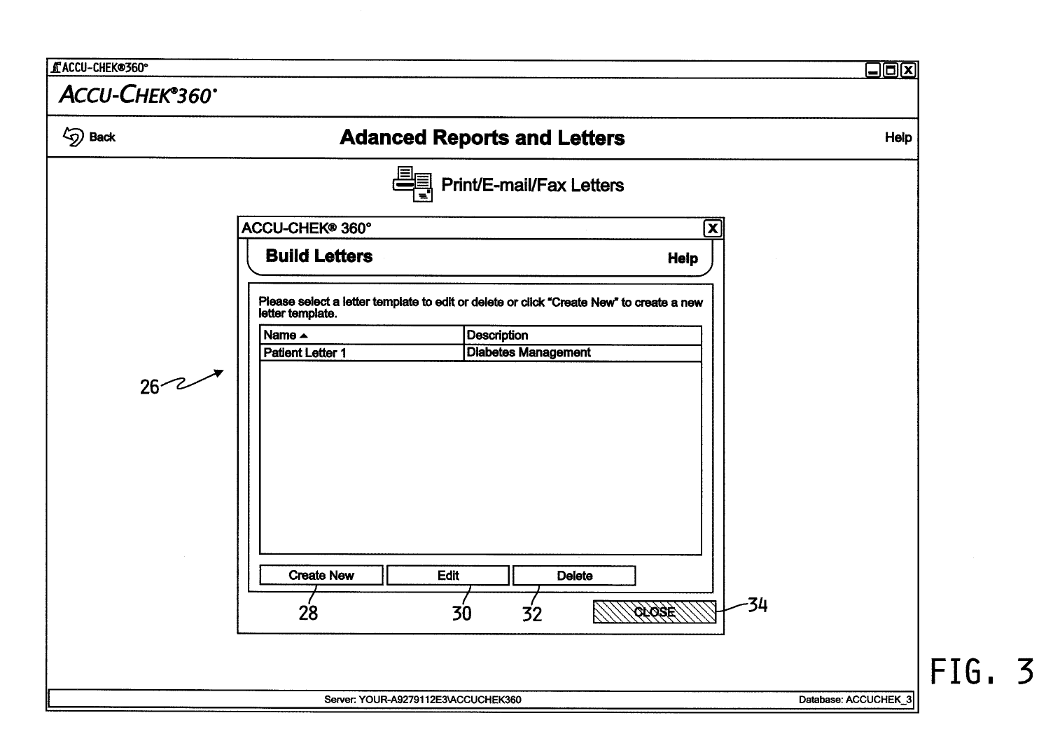

To create custom letter templates for reporting medical information, the user first selects the “build letters” icon 20. Selecting the “build letters” icon 20 displays a “letters menu” 26 that lists the available letters stored in the system (FIG. 3). “Letters menu” 26 includes a “create new” icon 28, an “edit” icon 30, a “delete” icon 32 and a “close” icon 34. In the embodiment shown, the “letters menu” 26 includes one stored letter template entitled “Patient Letter 1.”

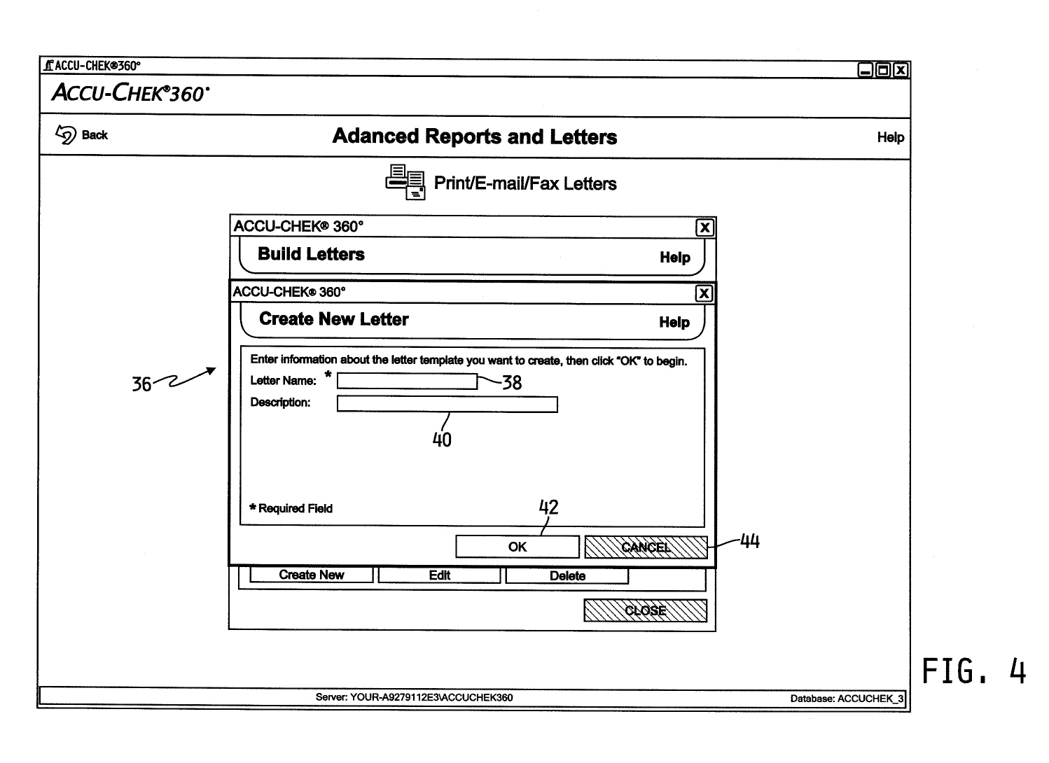

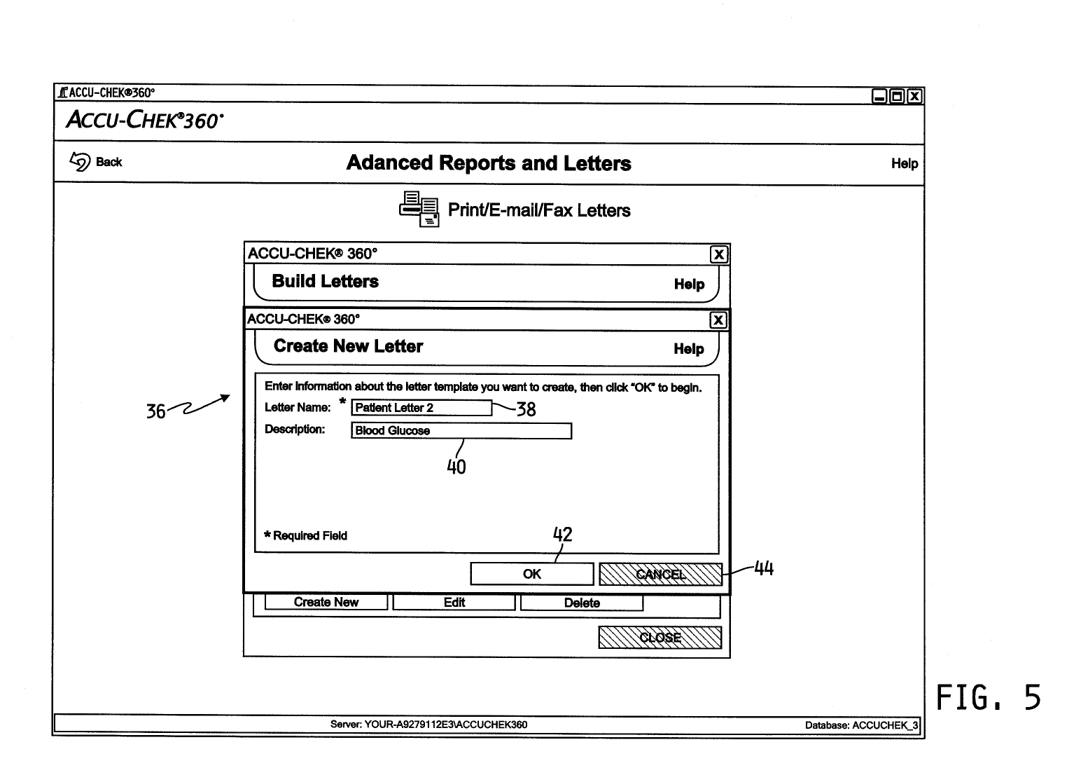

To create new letter templates, the user selects “create new” icon 28 which causes “create new letter” screen 36 to be displayed (FIG. 4). “Create new letter” screen 36 includes a text box 38 for entering the name of the new letter and a text box 40 for entering a description of the new letter. Entering text in boxes 38 and 40 causes “OK” icon 42 to become active (FIG. 5). “Create new letter” screen 36 further includes a “cancel” icon 44.

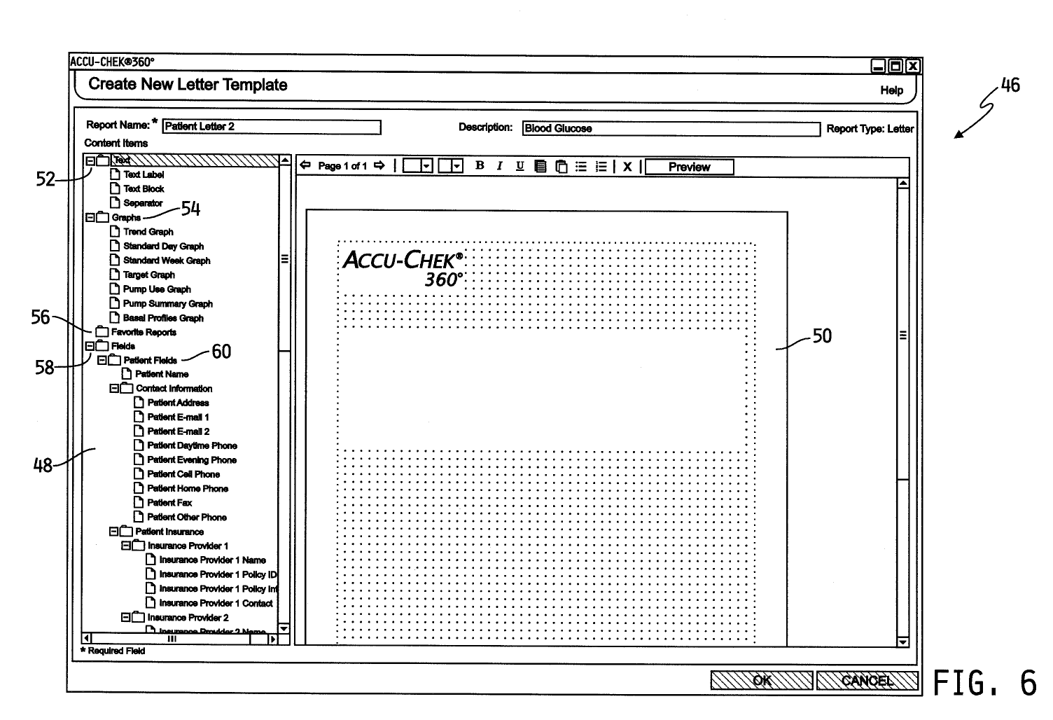

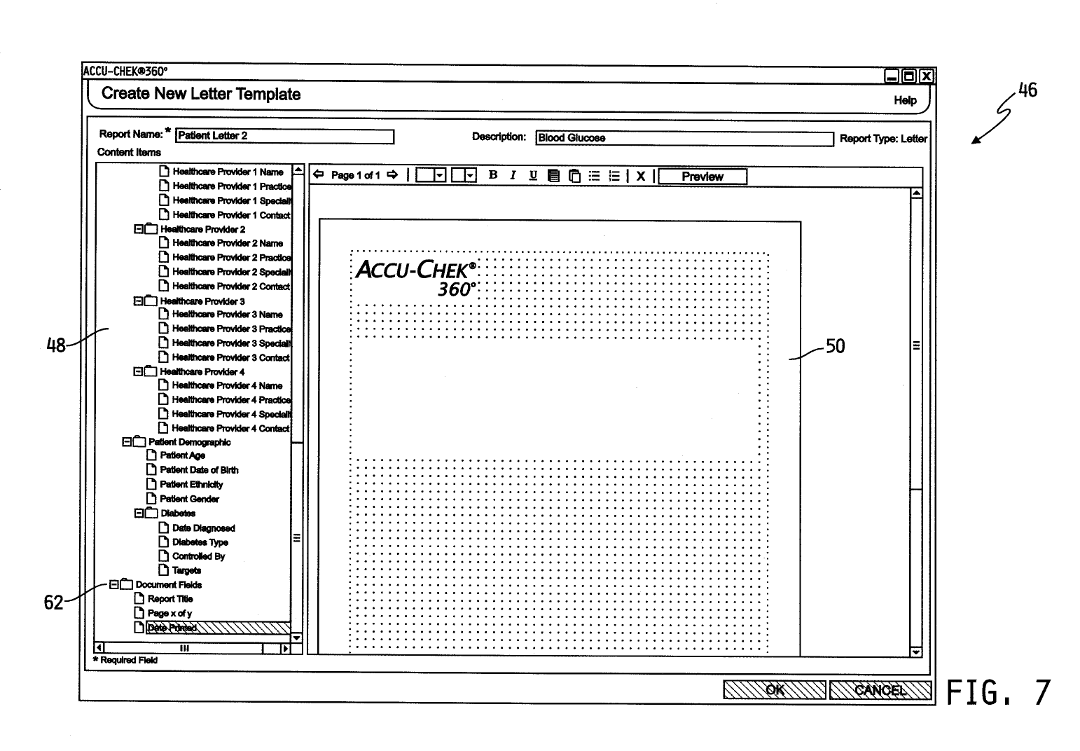

After entering the letter name and description, selecting “OK” icon 42 displays a “create new letter” template 46 (FIG. 6). Template 46 is generally divided into a first or content items section 48 and a second or template section 50. Content items section 48 includes a variety of content that can be utilized to create the letter template. For example, text content 52 includes various tools for placing written text in template section 50. Graphs content 54 includes various graphs stored in the system database that can be included in template section 50. Favorite reports content 56 includes the particular user's favorite or most frequently used reports. Fields content 58 includes patient content 60, which can include information such as (a) the patient's name, address, e-mail, phone numbers, fax numbers and other contact information, (b) insurance information including insurance provider, name, contact information and policy numbers, (c) patient healthcare provider information such as the healthcare provider's names, contact information and (d) patient demographic information such as the patient's age, birth date, ethnicity, gender and information regarding the patient's medical condition such as the date they were diagnosed with a particular disease (such as diabetes), the type of diabetes and other information. The document content 62 (FIG. 7) includes content that can be utilized in template section 50 to identify information about the document itself, such as its title, page numbers, the date the document was generated and other information.

The various content items may be stored in the system database in various forms. For example, blood glucose readings and other data for individual patients may be stored in the database and associated with the patient's name. Graph templates may be stored in the system database and populated with other stored data when the graph is generated for output as part of a report or letter, as described below.

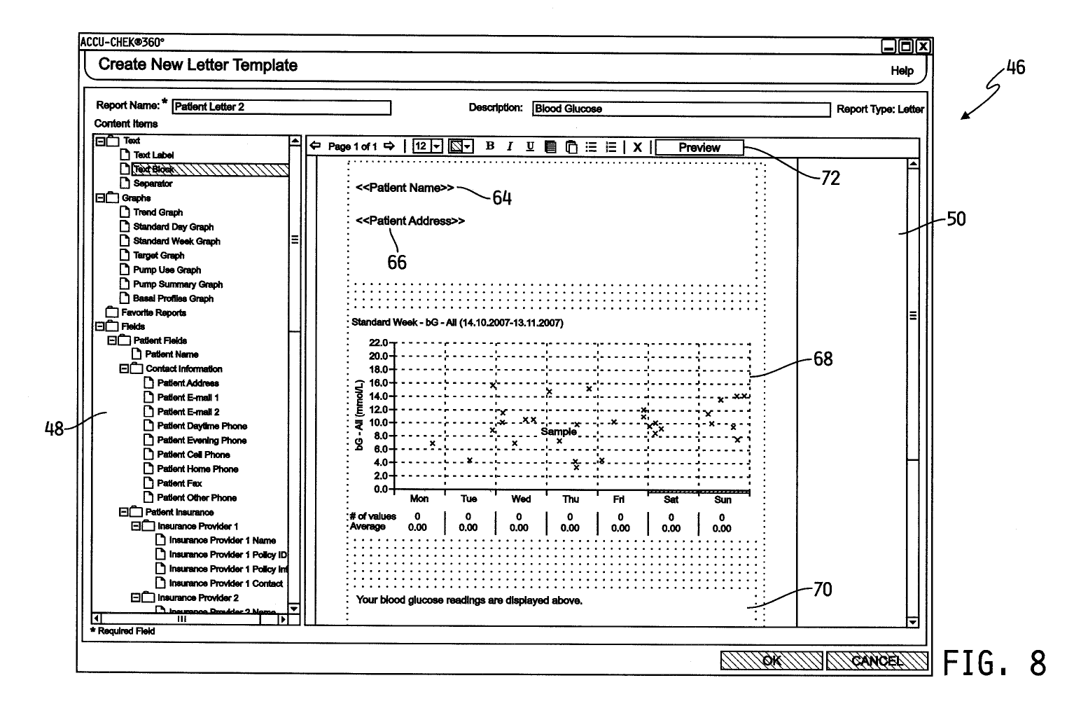

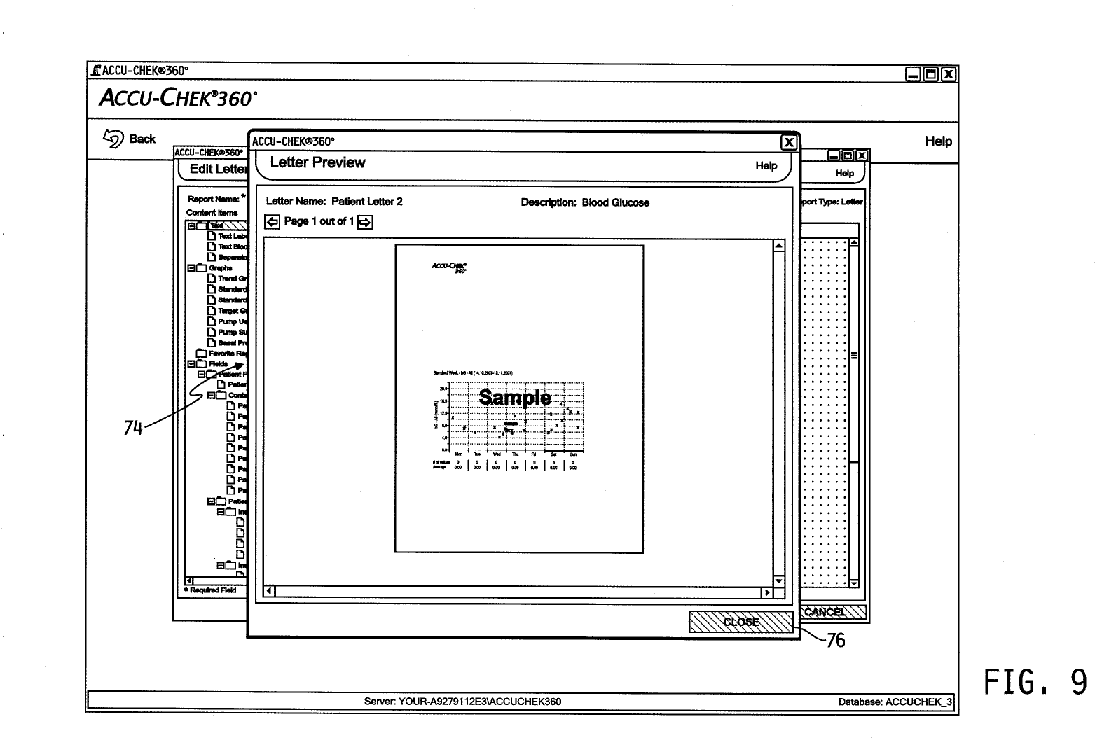

Letter templates can be generated by utilizing a mouse or other known hardware to drag and drop items from content items section 48 to template section 50. For example, in the template shown in FIG. 8, the patient name content 64 and patient address content 66 have been dragged and dropped from content section 48 to template section 50. The standard week graph 68 (which displays blood glucose measurements for a week) has also been dragged and dropped into template section 50. A text box 70 has also been dragged and dropped into the template section 50 and populated with the phrase “your blood glucose readings are displayed above.” The user may, of course, select any desired combination of the content items for use in template section 50. If the user desires to preview the template prior to saving it, the user simply activates the “preview” icon 72. This causes a “letter preview” window 74 to be displayed which shows the format of the letter produced by the template (FIG. 9). To return to the “create new letter” template 46, the user simply selects the “close” icon 76.

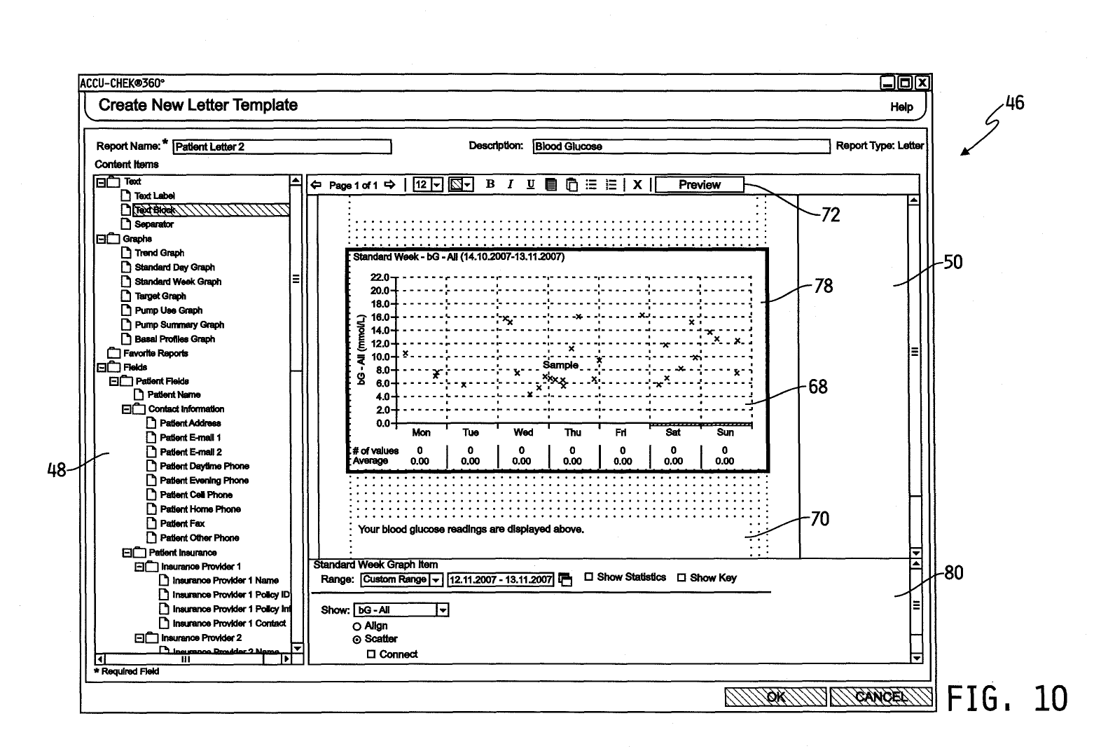

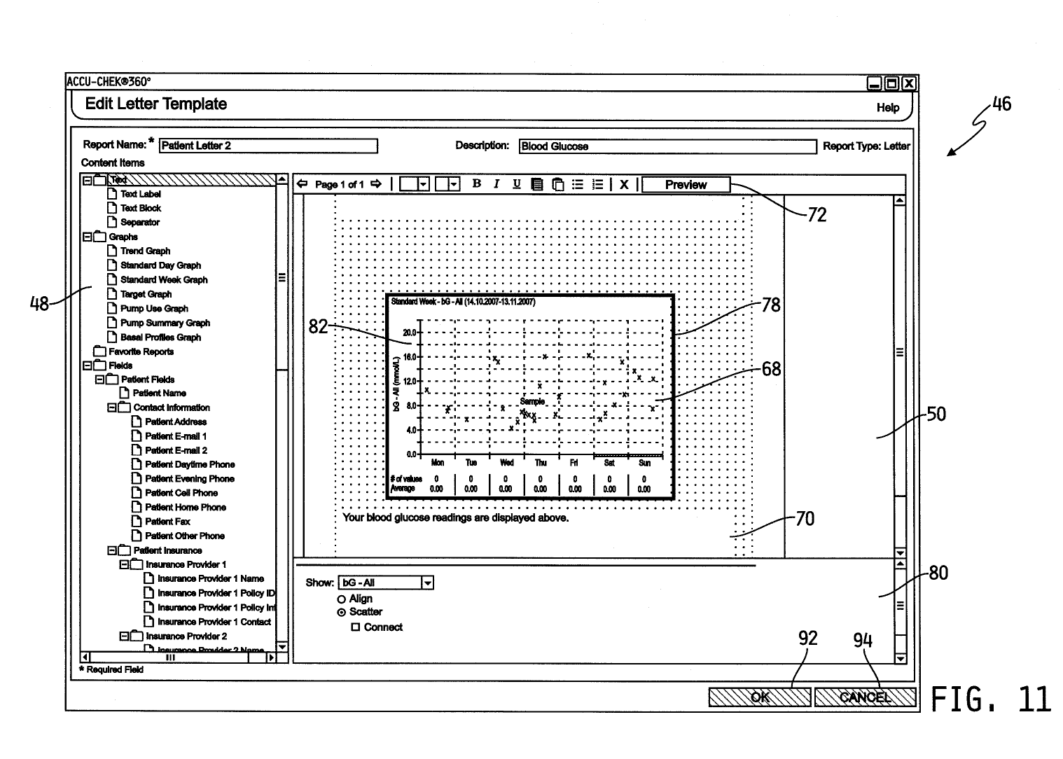

In one embodiment of the invention, the user can adjust the scale and content of the graphs and other information that have been dragged and dropped to template section 50. For example, if the user desires to alter the graph 68, he or she can position a cursor over the graph and click. This causes a boundary box 78 to be displayed around graph 68 and a “graph content” menu 80 to be displayed at the bottom of template section 50 (FIG. 10). The cursor can then be used to expand or contract boundary box 78 by positioning the cursor over a portion of the box and dragging it to increase or decrease the size, as is known in the art. For example, as shown in FIG. 11, boundary box 78 has been reduced in size, thereby reducing the size of graph 68. Note also that as graph 68 has been reduced in size, the y axis scale 82 has been relabeled to account for the change in the size. In FIG. 10, y axis scale 82 is marked in increments of 2 mmol/L, whereas in FIG. 11 it is marked in increments of 4 mmol/L. That is, adjusting boundary box 78 to adjust to size of graph 68 does not merely change the size of graph 68 but also reformats the x and y scales as needed.

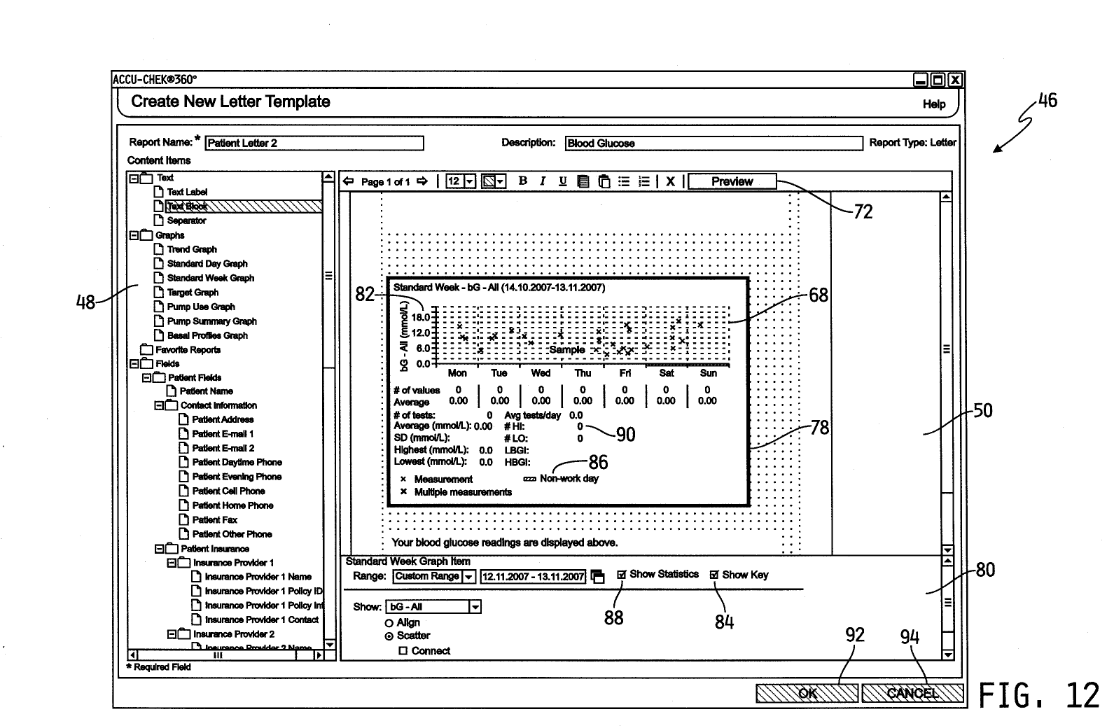

The present invention also allows the user to select desired content for graph 68 from the graph content menu 80. For example, if the user selects the “show key” box 84, the key 86 for reading graph 68 is displayed beneath it (FIG. 12). Note that the addition of key 86 has also caused y axis 82 to be further relabeled. Similarly, selecting the “show statistics” box 88 displays various statistics 90 in conjunction with graph 68. Clicking outside of boundary box 78 causes boundary box 78 and graph content menu 80 to disappear.

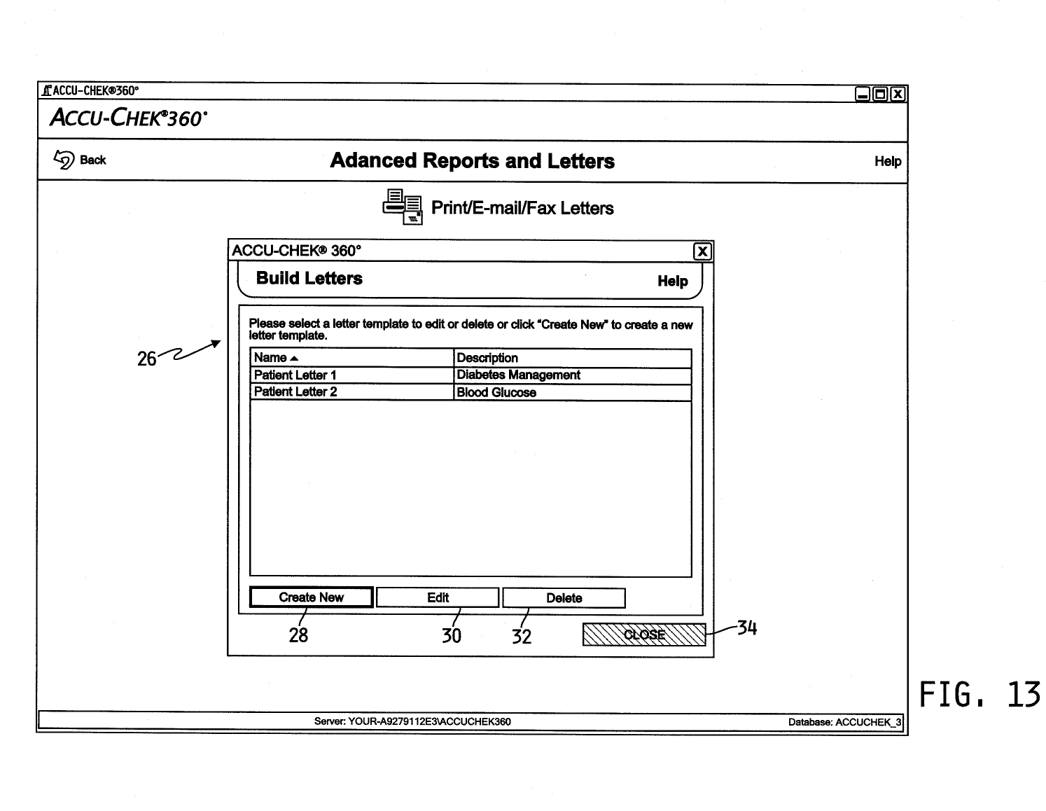

When the user is satisfied with the content of template section 50, he or she selects “OK” icon 92 to save the template in the system database with the previously stored letter and report templates. Selecting “OK” icon 92 also returns the user to “letters menu” 26 which now includes newly created Patient Letter 2 (FIG. 13). Alternatively, the user can select “cancel” icon 94 to abandon the operation and return to letters menu 26.

If the user wants to edit a template, he or she highlights the template to be edited and selects “edit” icon 30. This causes the stored template to be displayed with its content items section 48 and template section 50. The template can then be edited by dragging and dropping content, resizing graphs, changing text, etc. as described in connection with the method for creating the template. A stored letter template can be deleted by highlighting the template in menu 26 and selecting “delete” icon 32. Selecting “close” icon 34 returns the user to the “advanced reports and letters” menu 14.

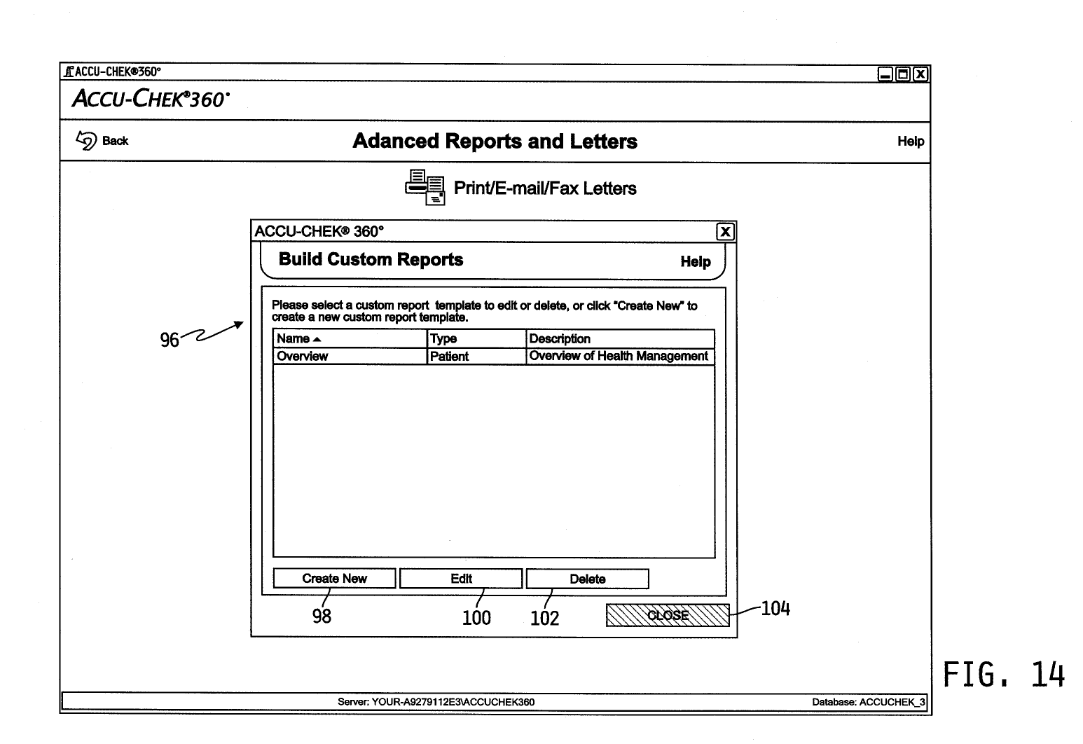

Returning to FIG. 2, selecting “build custom reports” icon 22 displays a “reports menu” 96 that lists the available reports stored in the system (FIG. 14). “Reports menu” 96 includes a “create new” icon 98, an “edit” icon 100, a “delete” icon 102 and a “close” icon 104. In the embodiment shown, the “reports menu” 96 includes one stored report template entitled “Overview.”

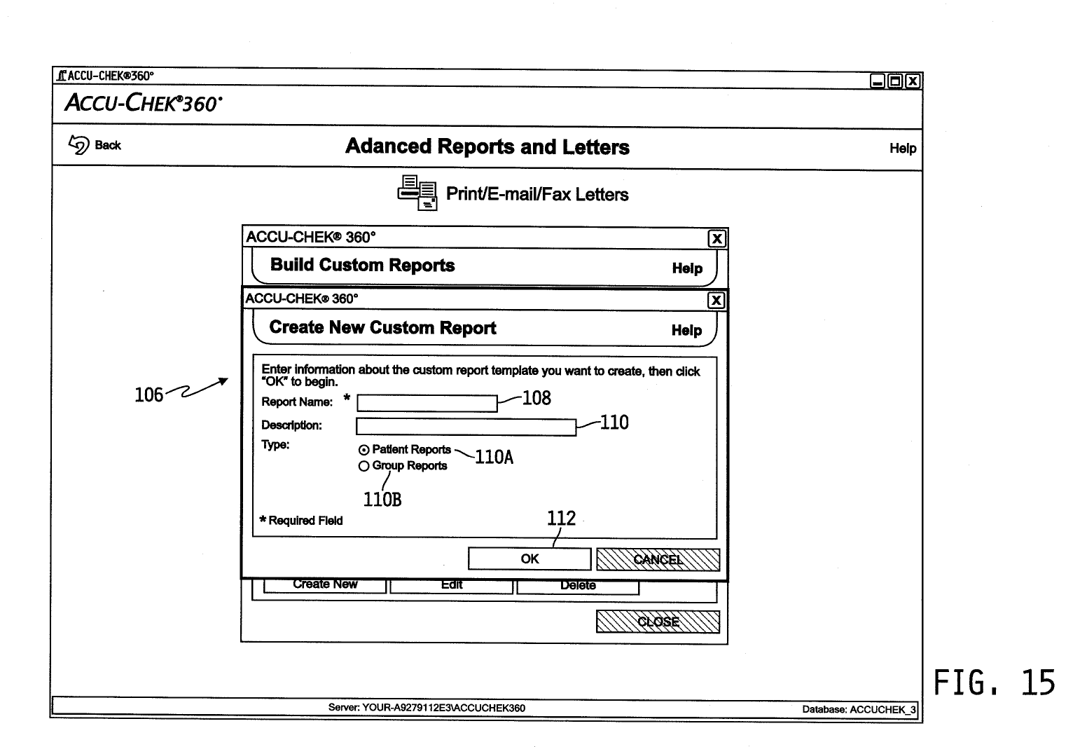

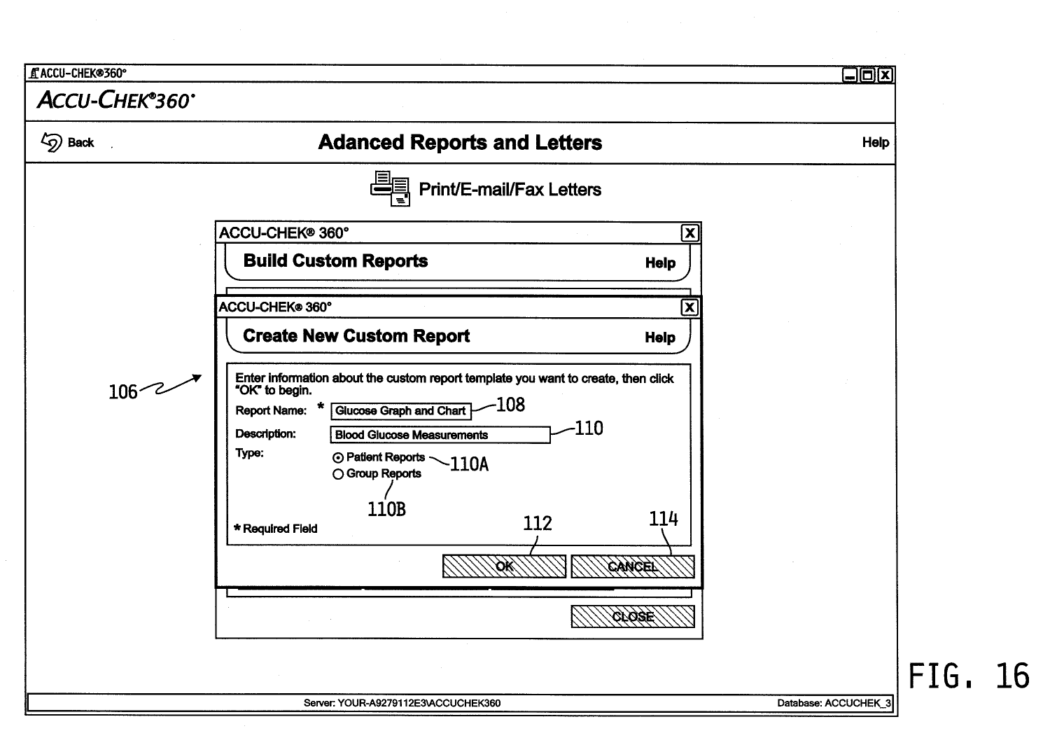

To create new report templates, the user selects “create new” icon 98 which causes “create new report” screen 106 to display (FIG. 15). “Create new report” screen 106 includes a text box 108 for entering the name of the new report and a text box 110 for entering a description of the new report. Entering text in boxes 108 and 110 causes “OK” icon 112 to become active (FIG. 16) “Create new report” screen 106 further includes a “cancel” icon 114. “Create new report” screen 106 also allows the user to define the report template type. In the example shown, the user can define the report as a patient report by selecting “patient report” option 110A or as a group report by selecting “group report” option 110B. In this manner, report templates can be created for reporting individual patient data or group patient data. For example, a user may want to create a report template for reporting data relating to a group of patients that are the same age, the same gender or that began a particular treatment at a particular time.

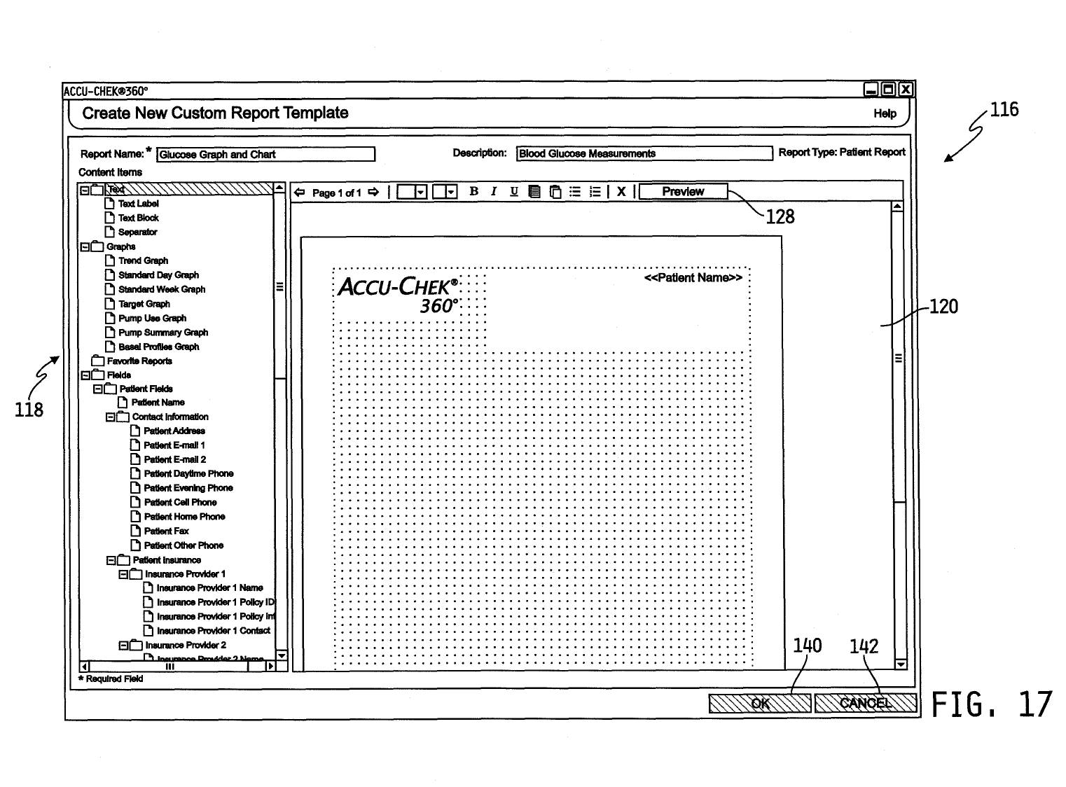

After entering the report name and description, selecting “OK” icon 112 displays a “create new report” template 116 (FIG. 17). Template 116 is generally divided into a first or content items section 118 and a second or template section 120. As with content section 48 described above, content items section 118 includes a variety of content that can be utilized to create the report template. This content can be the same as or different from the content in section 48.

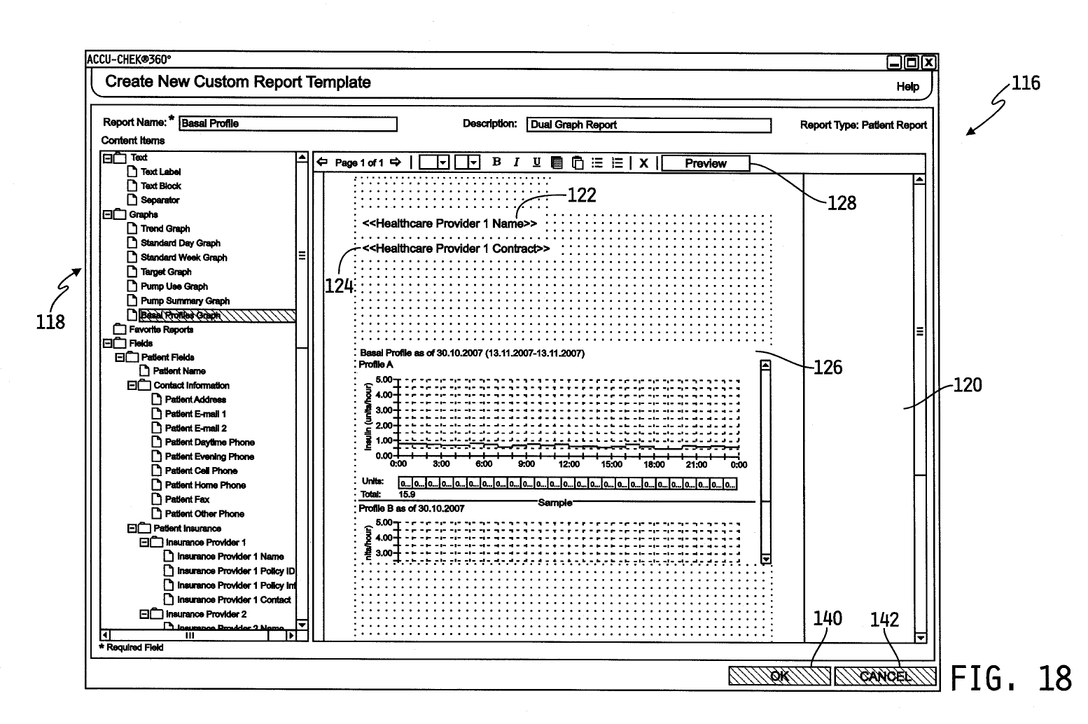

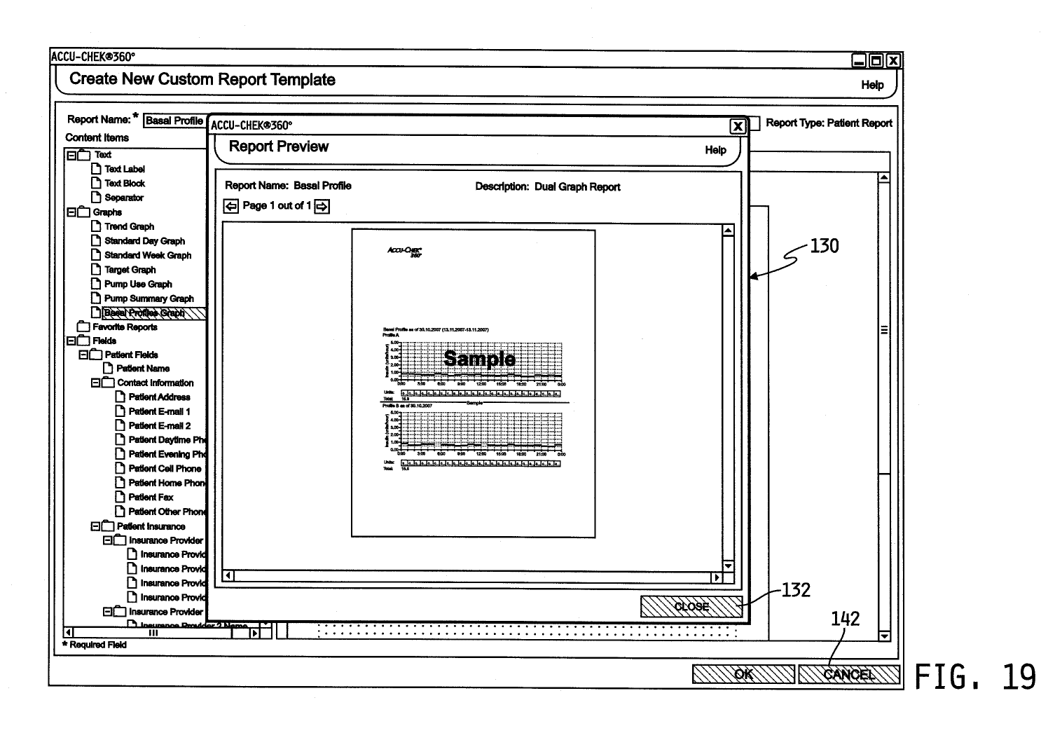

Report templates can be generated by utilizing a mouse or other known hardware to drag and drop items from content items section 118 to template section 120 in the same manner as described above with respect to “create new letter” template 46. For example, in the template shown in FIG. 18, the “healthcare provider 1 name” content 122 and “healthcare provider 1 contact” content 124 have been dragged and dropped from content items section 118 to template section 120. The basal profiles graph 126 (which displays information relating to insulin) has also been dragged and dropped into template section 120. As with building letters templates, the user may select any desired combination of the content items for use in template section 120. If the user desires to preview the template prior to saving it, the user simply activates the “preview” icon 128. This causes a “report preview” window 130 to be displayed which shows the format of the report produced by the template (FIG. 19). To return to the “create new report” template 116, the user simply selects the “close” icon 132.

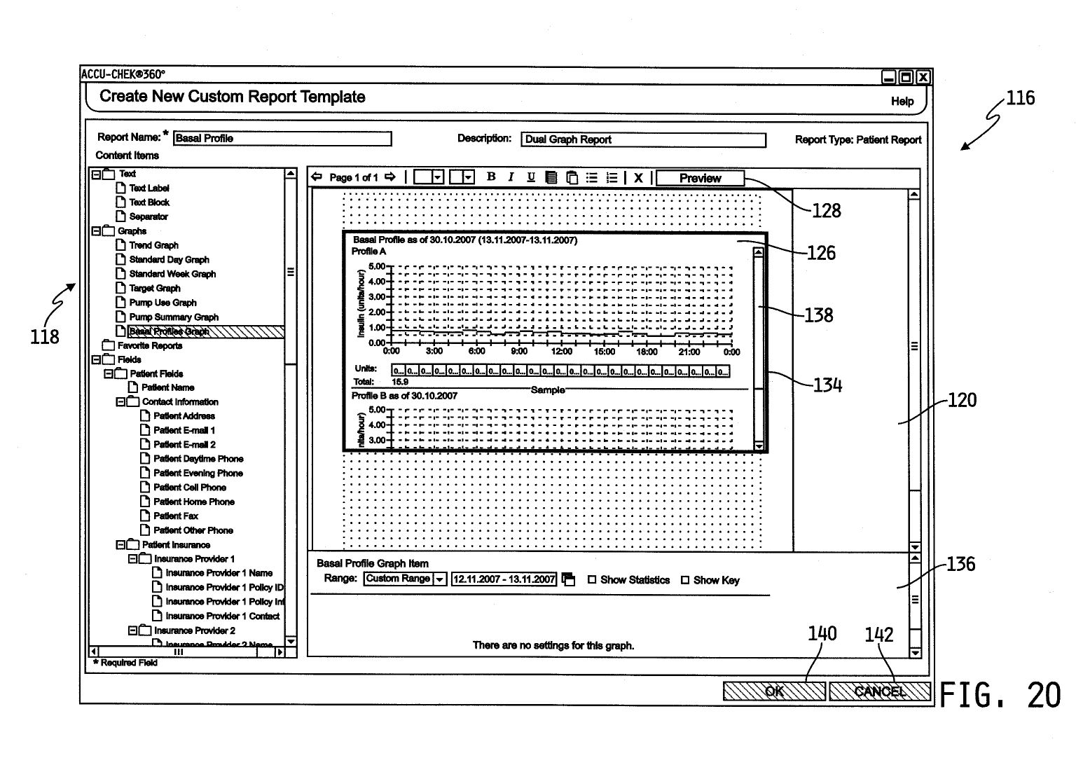

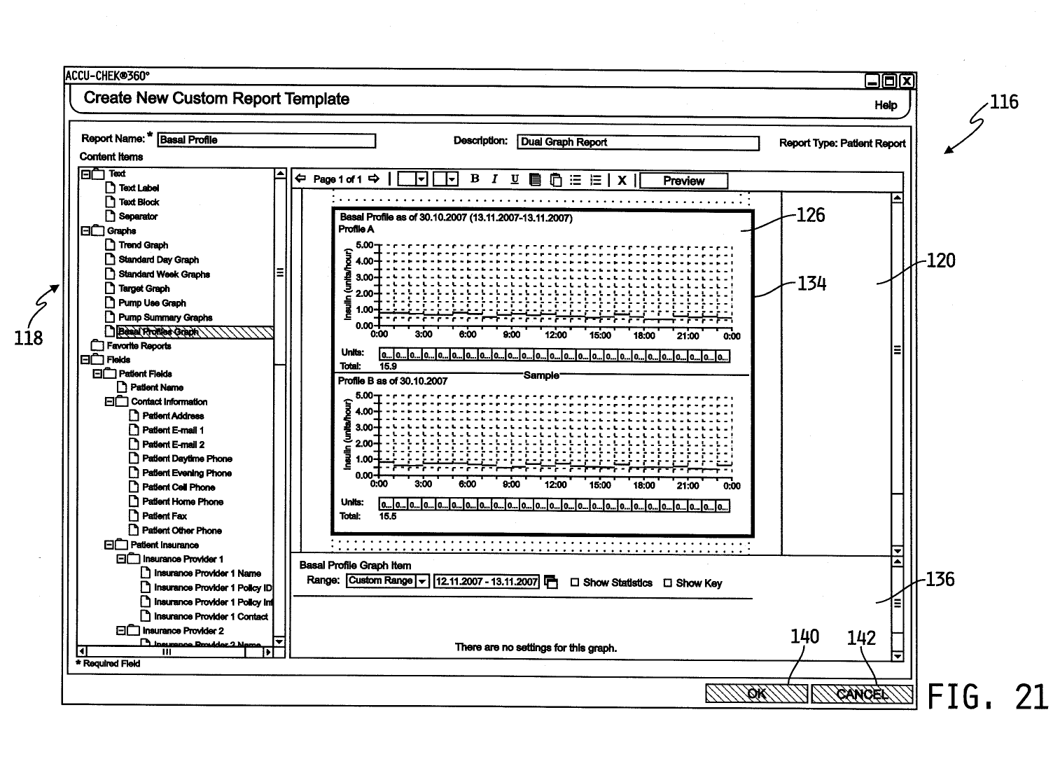

When building custom report templates, the user can adjust the scale and content of the graphs and other information that have been dragged and dropped to template section 120 in the same manner as described above. For example, if the user desires to alter the graph 126, he or she can position a cursor over the graph and click. This causes a boundary box 134 to be displayed around graph 126 and a graph content menu 136 to be displayed at the bottom of template section 120 (FIG. 20). The cursor can then be used to expand or contract boundary box 134 to increase or decrease the size of graph 126. Changing the size of graph 126 also causes the x and y axes to be relabeled as needed. Note that in FIG. 20, graph 126 included slide bar 138 because graph 126 is not large enough to appropriately display the entire graph. When graph 126 is sufficiently enlarged, slide bar 138 disappears (FIG. 21). Graph content menu 136 allows the user to display the graph key, statistics and to otherwise alter the content and form of graph 126 in the same manner as described in connection with creating custom letter templates.

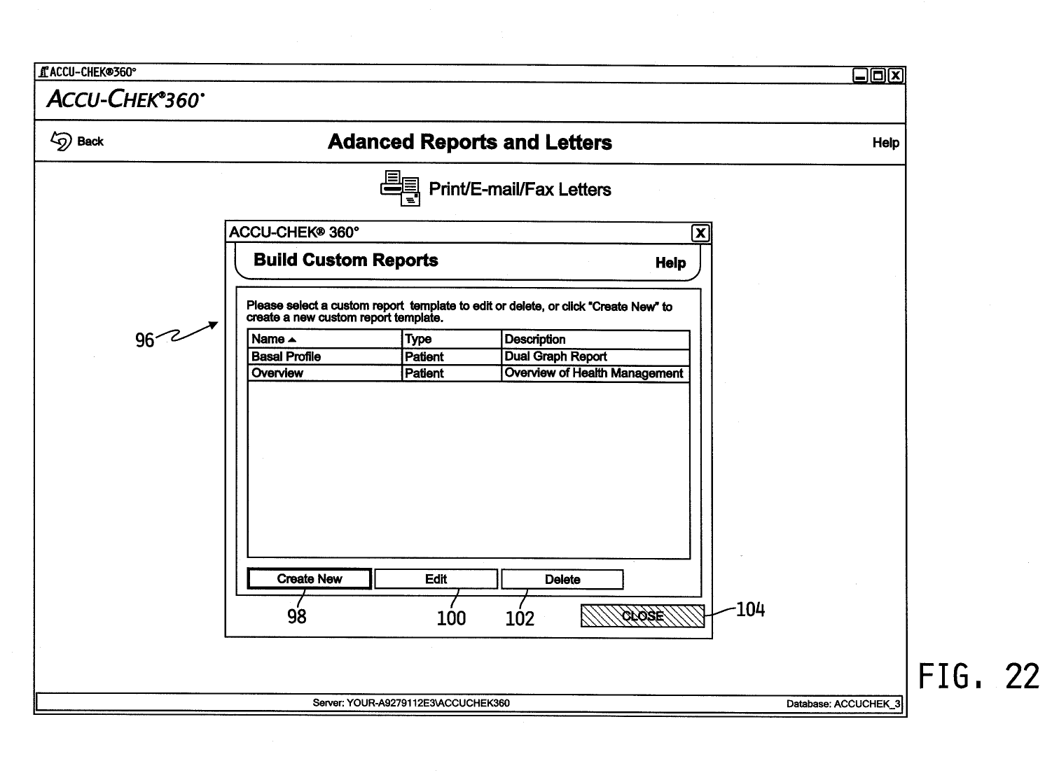

When the user is satisfied with the content of template section 120, he or she selects “OK” icon 140 to save the template. Selecting “OK” icon 140 returns the user to “reports menu” 96 which now includes a newly created Basal Profile report (FIG. 22). Alternatively, the user can select “cancel” icon 142 to abandon the operation and return to “reports menu” 96. Report templates can be deleted and edited in the same manner as described above by selecting icons 100 or 102. Selecting the “close” icon 104 returns the user to the “advanced reports and letters” menu 14.

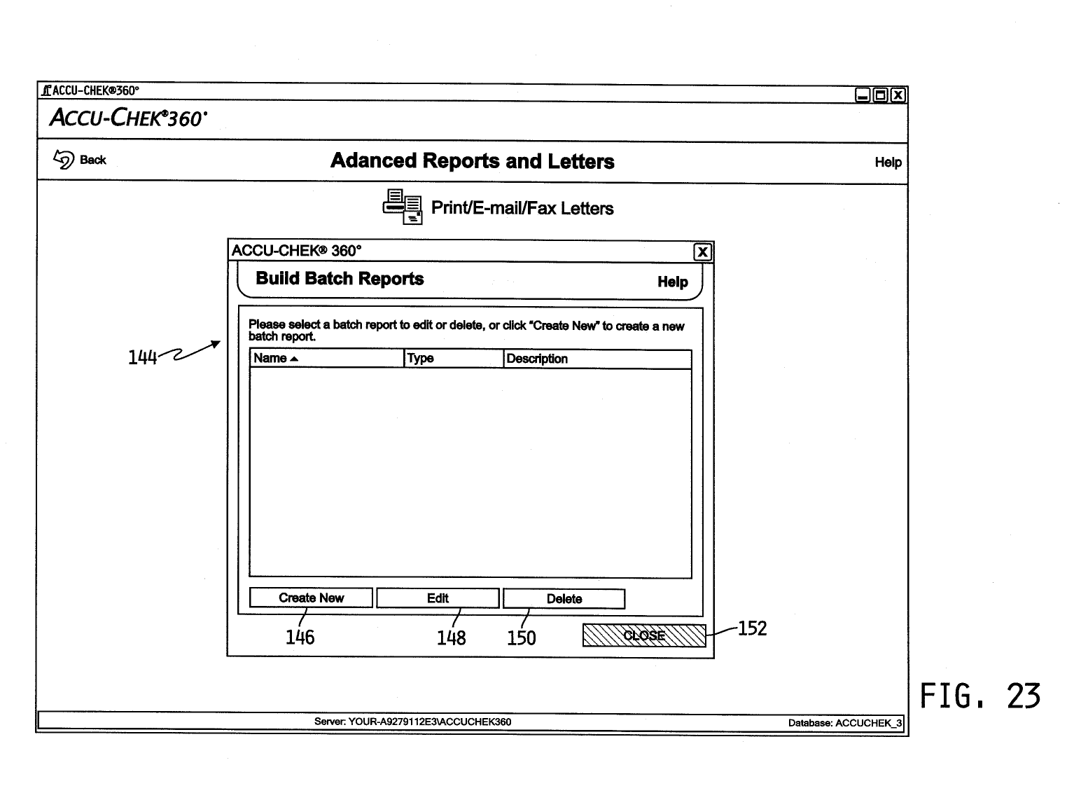

Referring again to FIG. 2, selecting “build batch reports” icon 24 displays a “batch reports menu” 144 that lists the available batch reports stored in the system (FIG. 23). A batch report is a combination of previously defined report templates that are stored in the system. In the example shown in FIG. 23, no batch reports have been defined. “Batch reports menu” 144 includes a “create new” icon 146, an “edit” icon 148, a “delete” icon 150 and a “close” icon 152.

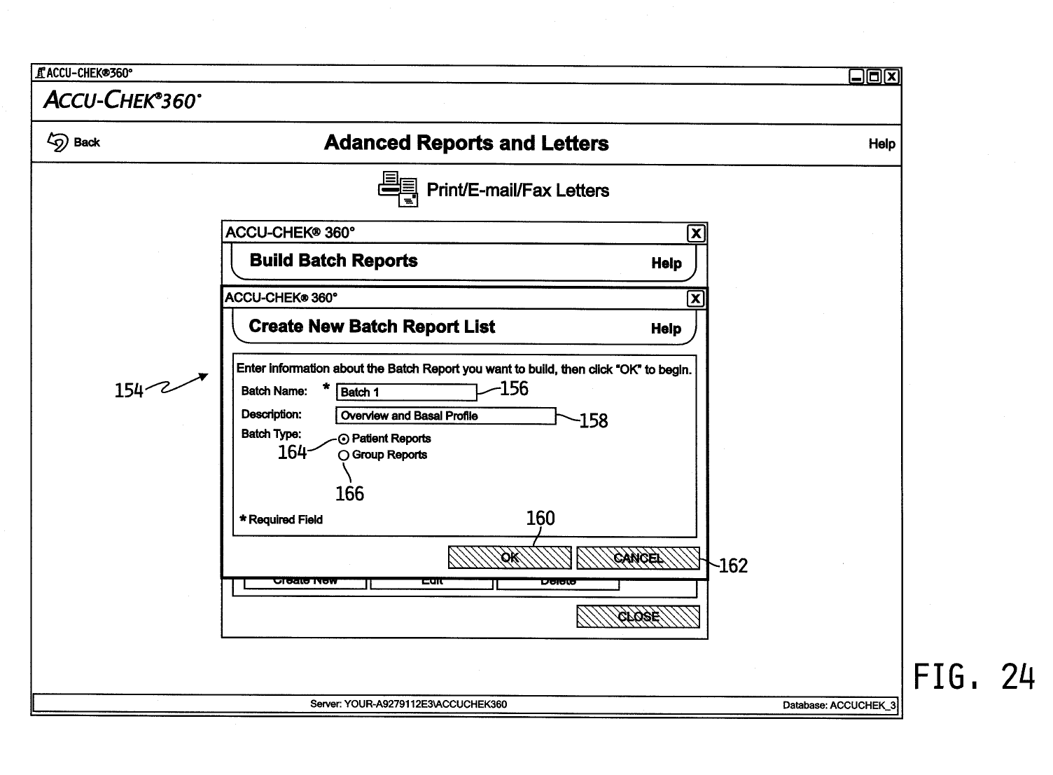

To create new batch report templates, the user selects “create new” icon 146 which causes “create new batch report” screen 154 to display (FIG. 24). “Create new batch report” screen 154 includes a text box 156 for entering the name of the new batch report and a text box 158 for entering a description of the new report. Entering text in boxes 156 and 158 causes “OK” icon 160 to become active. “Create new batch report” screen 154 further includes a “cancel” icon 162. As with the “create new report” screen 106, screen 154 allows the user to select a “patient report” option 164 or a group report option 166.

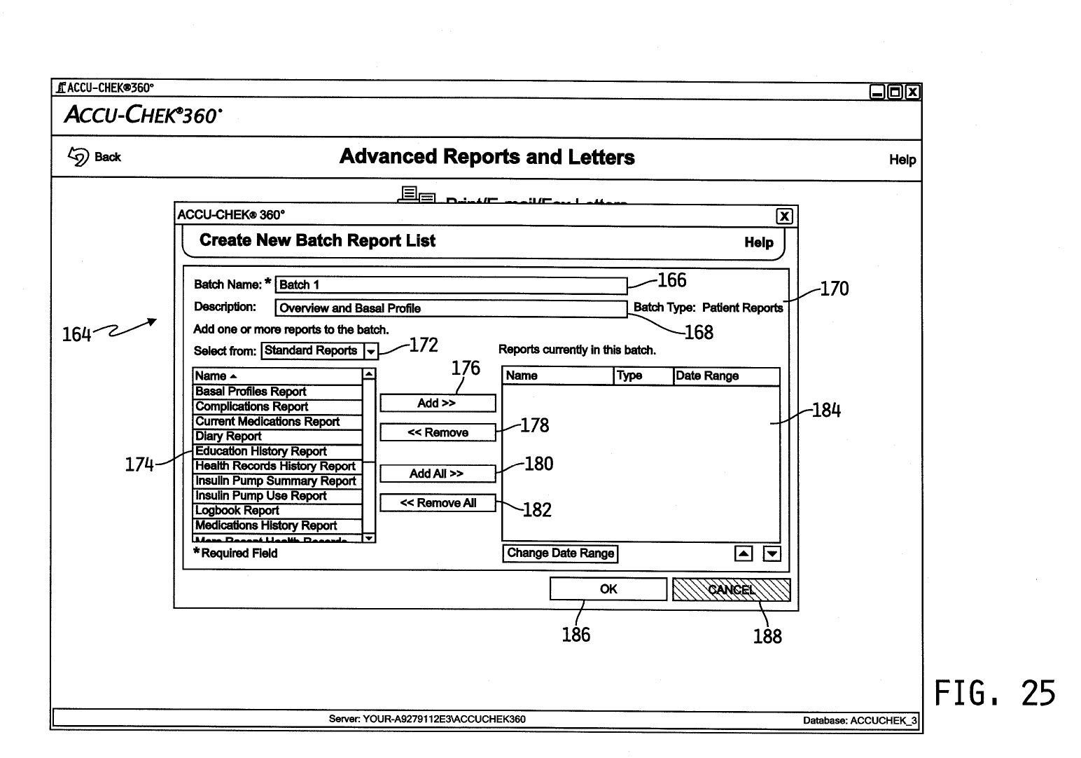

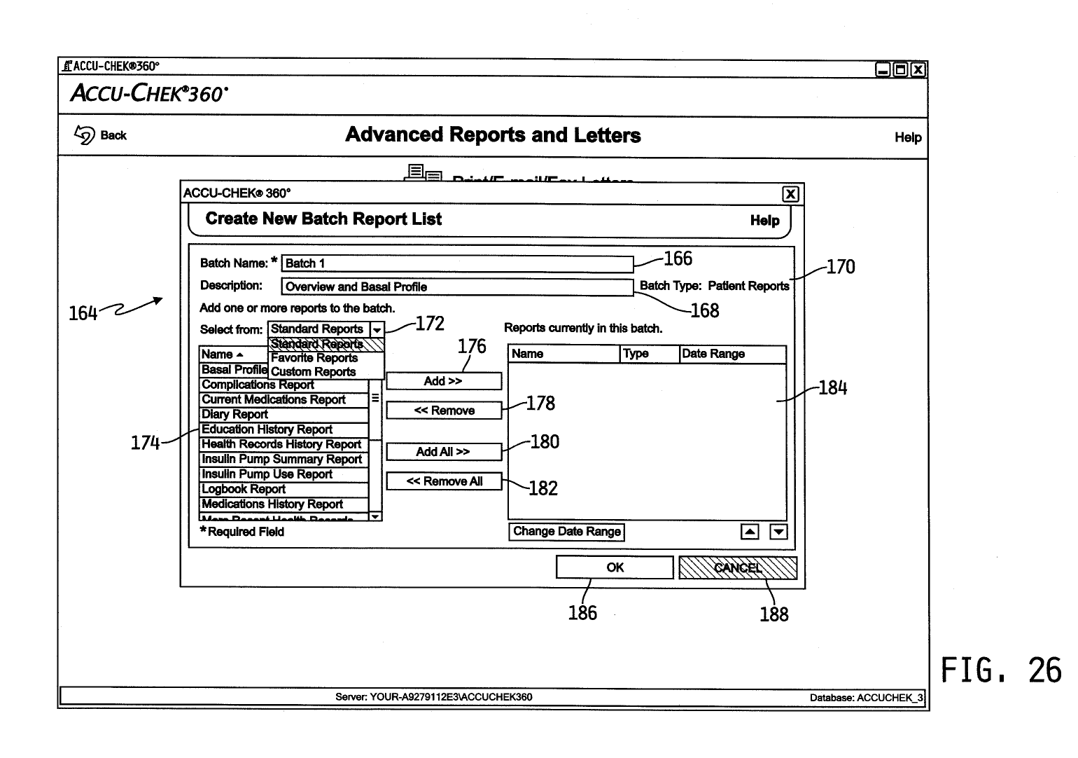

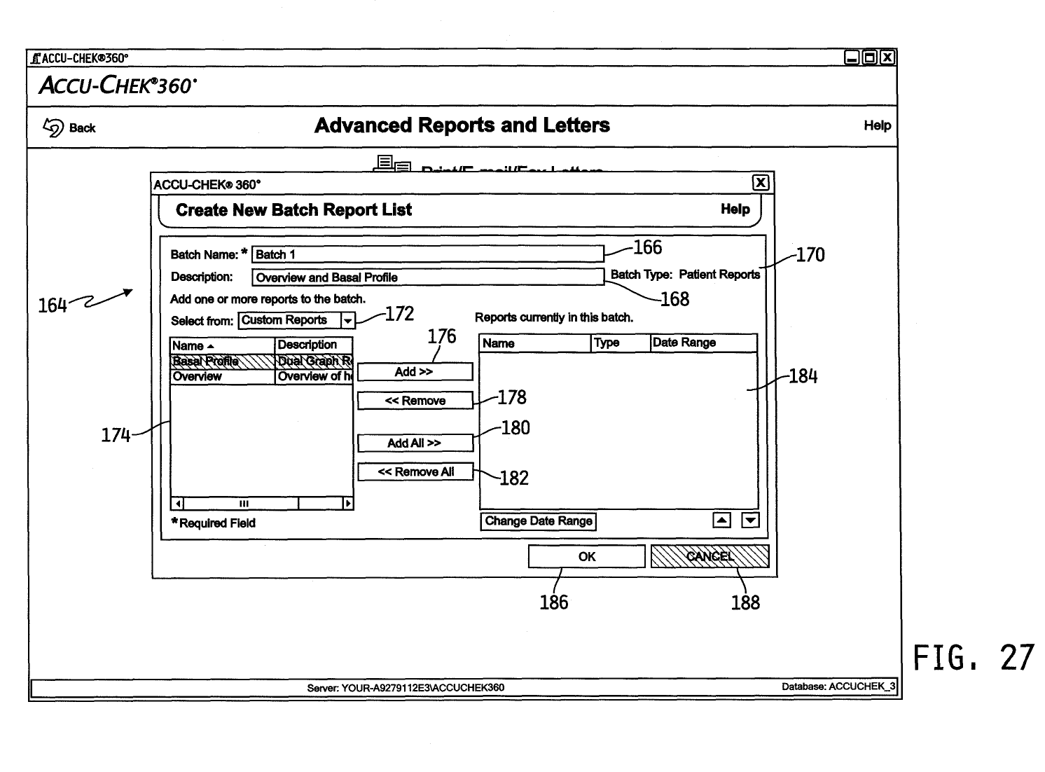

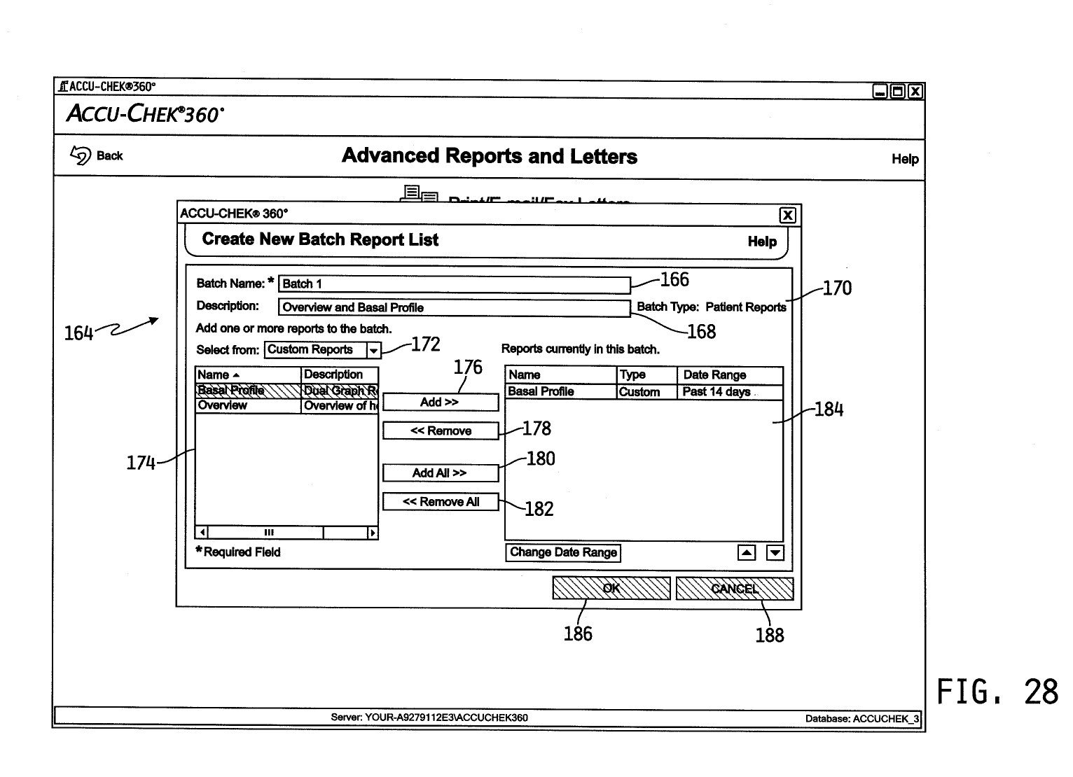

After entering the batch report name and description, selecting “OK” icon 160 displays a “create new batch report” list 164 (FIG. 25). List 164 displays the report's name in field 166 and the description in field 168. List 164 also identifies the report type in field 170. List 164 further includes a drop down menu 172 that allows the user to select between various report categories, such as standard reports, favorite reports and custom reports (FIGS. 25 and 26). For example, in FIG. 25, the standard reports category is selected in menu 172 and a list of standard reports stored in the system database appears in list field 174. Selecting “custom reports” from menu 172 displays the stored custom reports in field 174 (FIG. 27). “Create new batch report” list 164 further includes “add” icon 176, “remove” icon 178, “add all” icon 180 and “remove all” icon 182. List 164 further includes an included reports field 184, “OK” icon 186 and “cancel” icon 188.

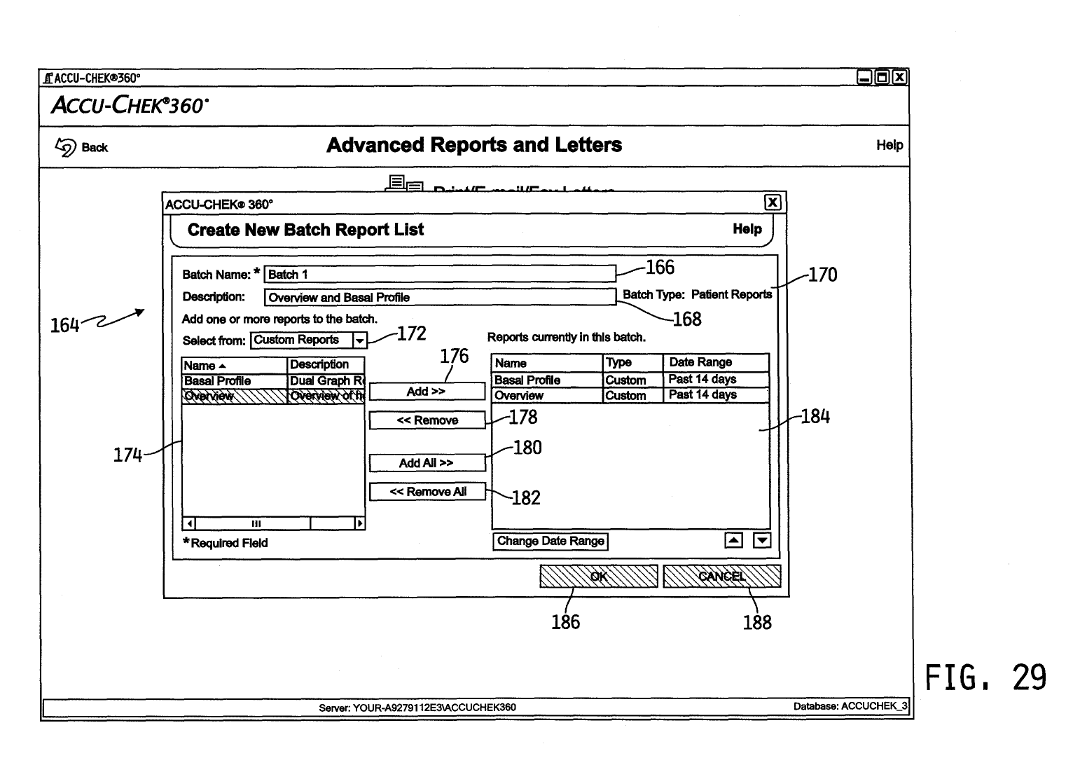

To create a batch report, the user highlights the desired report (such as the basal profile report as shown in FIG. 27) and selects “add” icon 176. This causes the desired report to be displayed in included report field 84. Highlighting the “overview” report and selecting “add” icon 176 causes that report to be added to included reports field 184 as well (FIG. 29). To remove a report from included report field 184, the user highlights the report and selects “remove” icon 178. Selecting “add all” icon 180 or “remove all” icon 182 will display all of the reports shown in field 174 in included report field 184 or remove all of the reports shown in included report field 184, respectively.

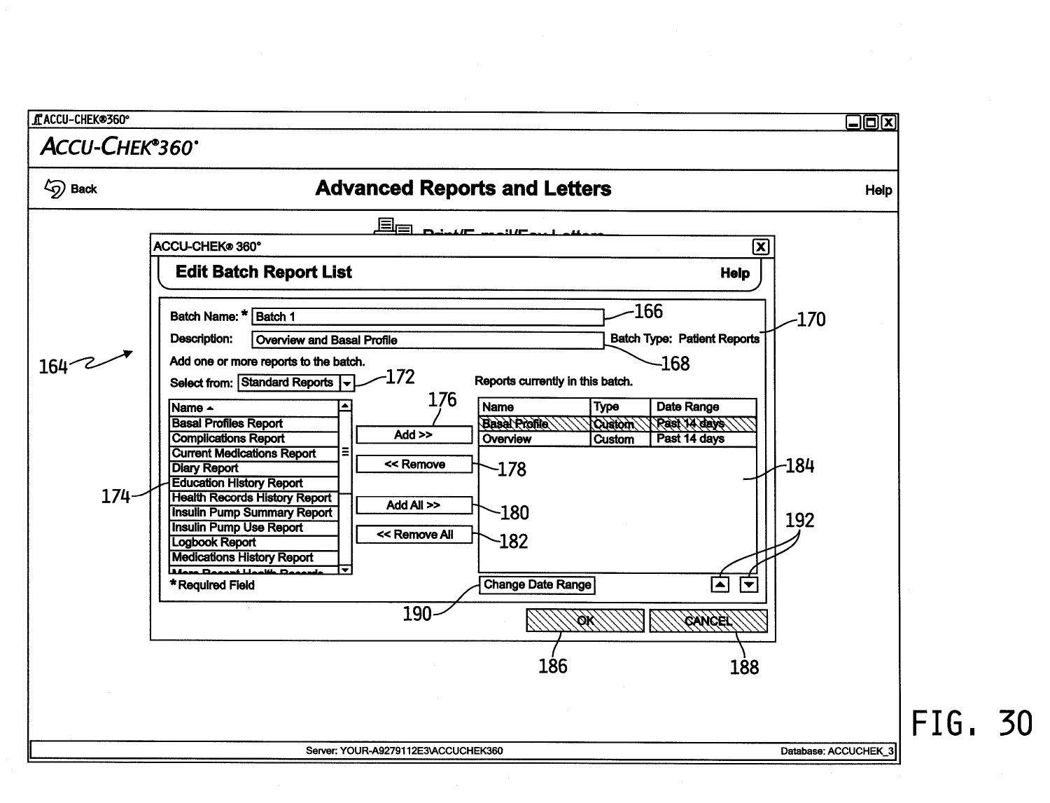

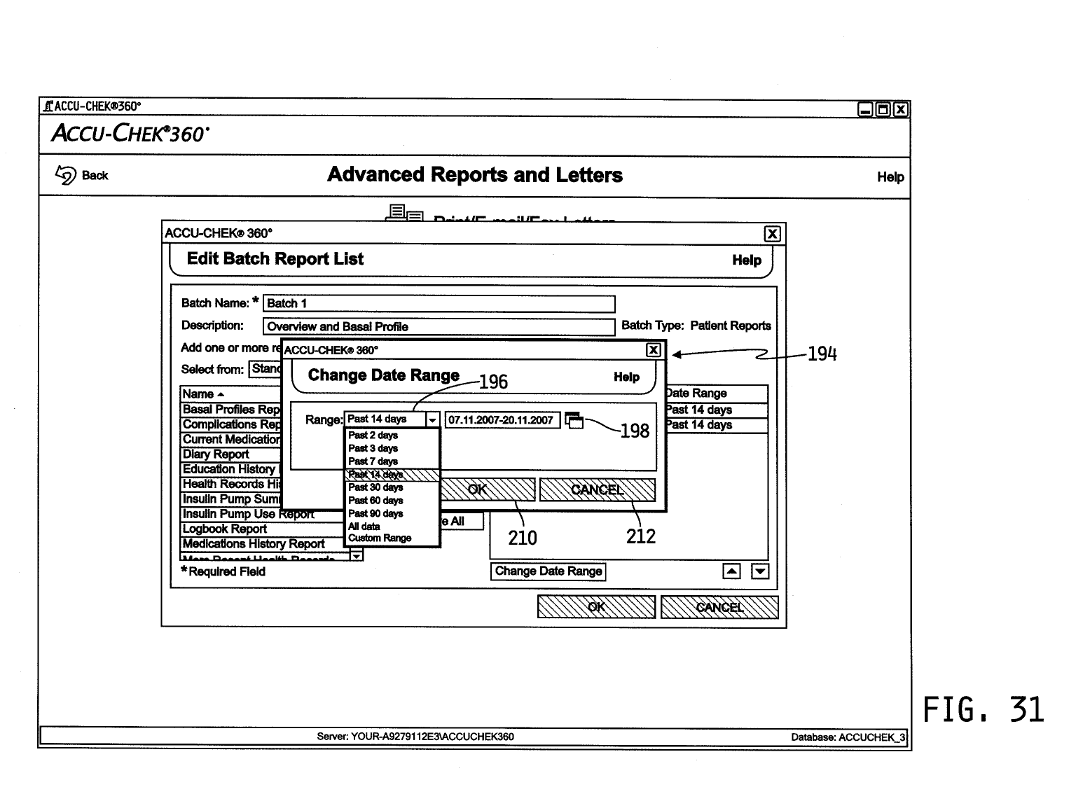

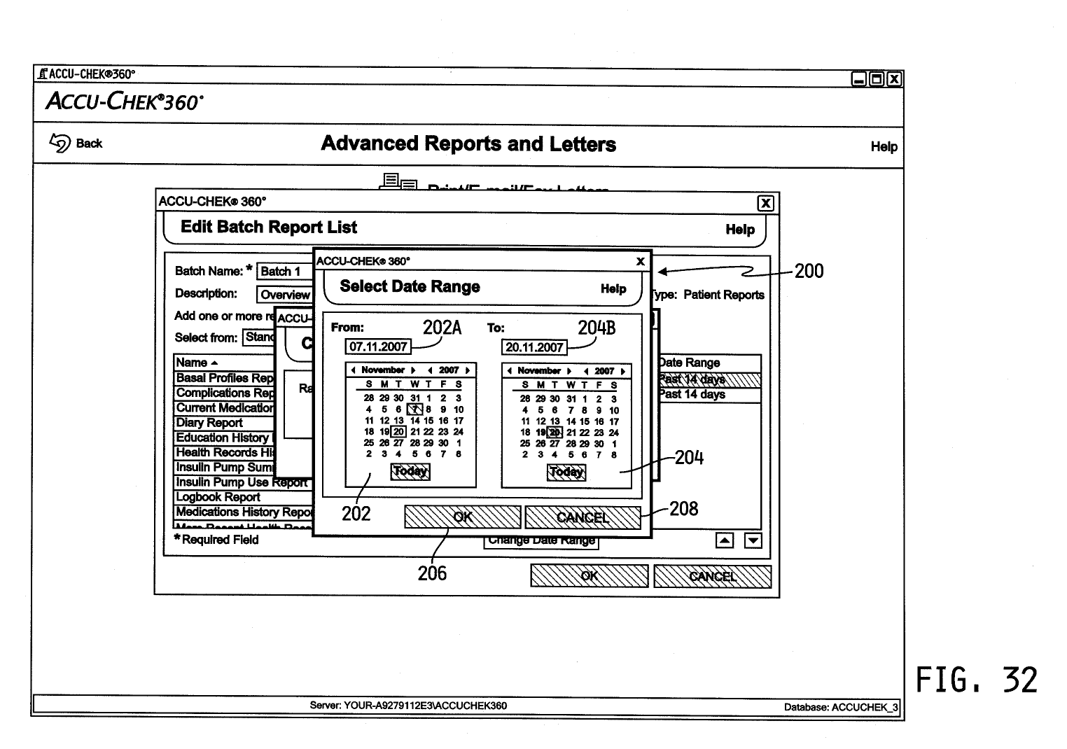

Once a report has been added to included reports field 184, the user may change the report date range. This is done by highlighting a report in field 184, which activates “change date range” icon 190 and scroll arrows 192 (FIG. 30). Selecting “change date range” icon 190 displays a “change date range” screen 194 (FIG. 31). The user can then select the desired date range from drop down menu 196. Alternatively, the user may select “calendar” icon 198 to display a select date range screen 200 (FIG. 32). The user can then select the desired dates from calendars 198, 200 as known in the art or enter the desired dates in text boxes 202A, 204B. When the user has selected the desired date range, selecting “OK” icon 206 returns the user to “change date range” screen 194. Alternatively, the user can abandon the operation by selecting “cancel” icon 208. Similarly, selecting “OK” icon 210 or “cancel” icon 212 from “change date range” screen 194 either saves the changes or abandons the operation.

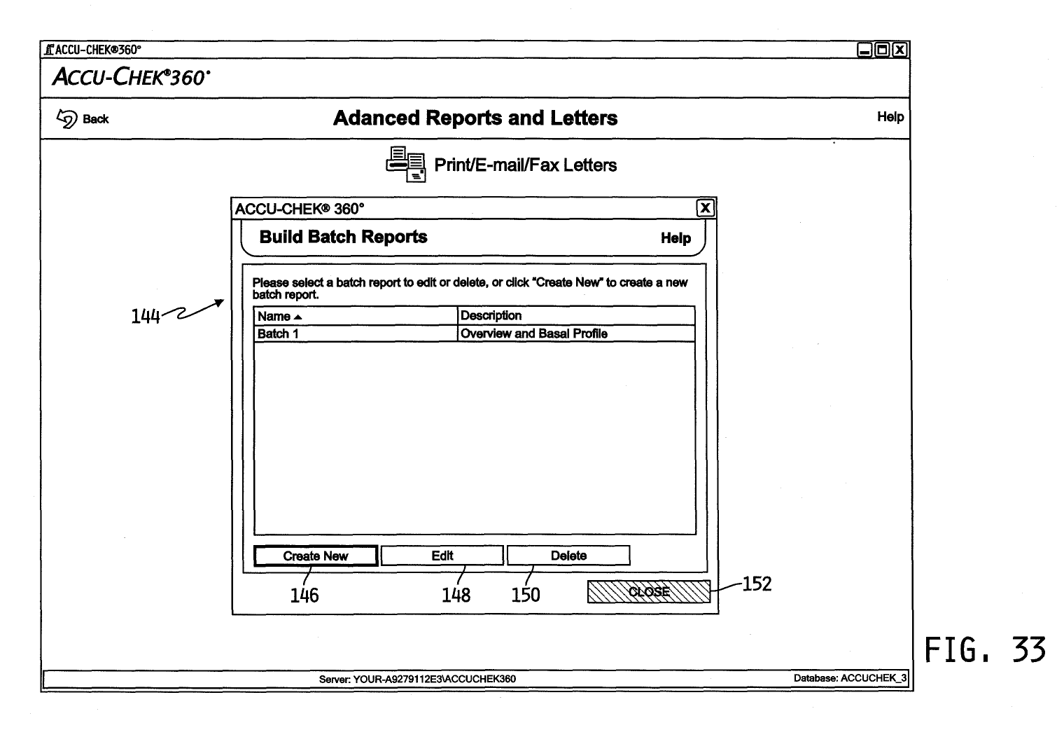

When the user is satisfied with the reports to be included in the new batch report, he or she selects “OK” icon 186 which returns the user to “build batch reports” screen 144, which now displays the newly created batch report (FIG. 33). Alternatively, selecting “cancel” icon 188 will abandon the operation and return the user to “build batch report” screen 144. To edit a batch report, the user highlights the report on screen 144 and selects the “edit” icon 148. This returns the user to an “edit batch report” screen (not shown) similar to list 164 and allows the user to edit the report through the use of icons 176 through 182. To delete a batch report, the user highlights the report on screen 144 and selects “delete” icon 150

Note that in one embodiment of the invention, batch reports can be created that include other batch reports. To do so, the user simply selects the “create new” icon 146 to be taken to the “create new batch report” screen 154. The use then enters the name and description of the report as described above. List 164 will then be displayed. Previously stored batch reports will be included in field 174 when the appropriate report category is selected from menu 172. The batch reports could be stored in a separate category, such as one entitled “batch reports,” or could be stored as custom or favorite reports. The previously defined batch reports are then added to “included reports” field 184 as described above and other batch reports or individual reports are added to the field to create a new batch report.

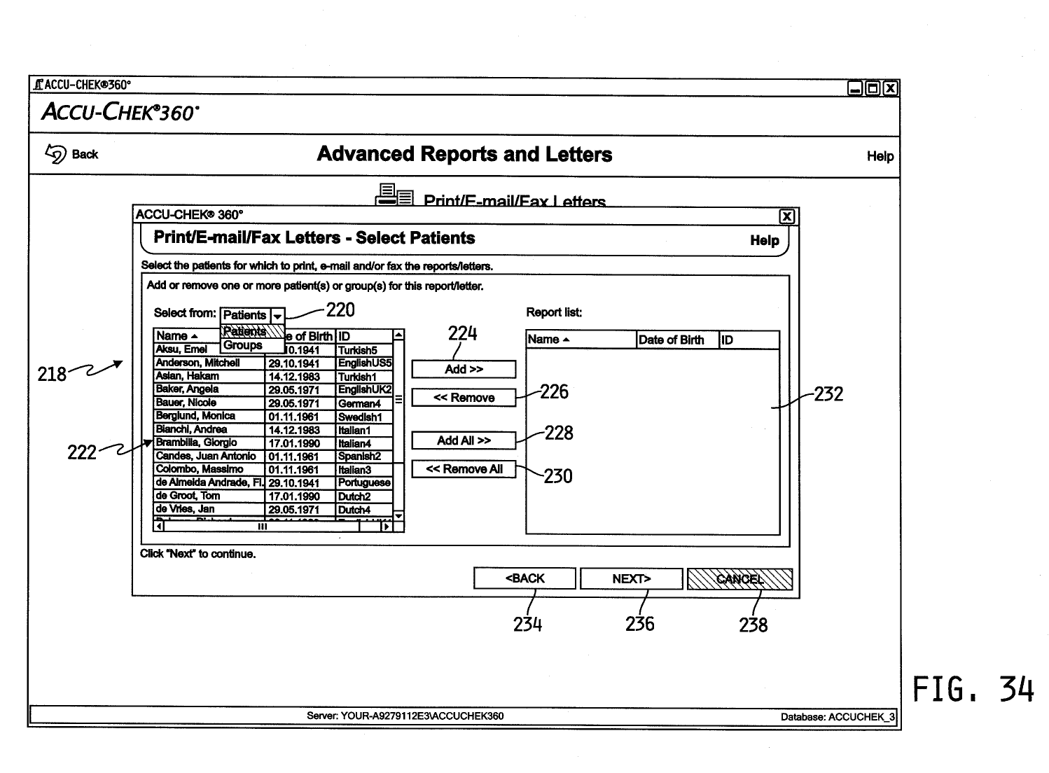

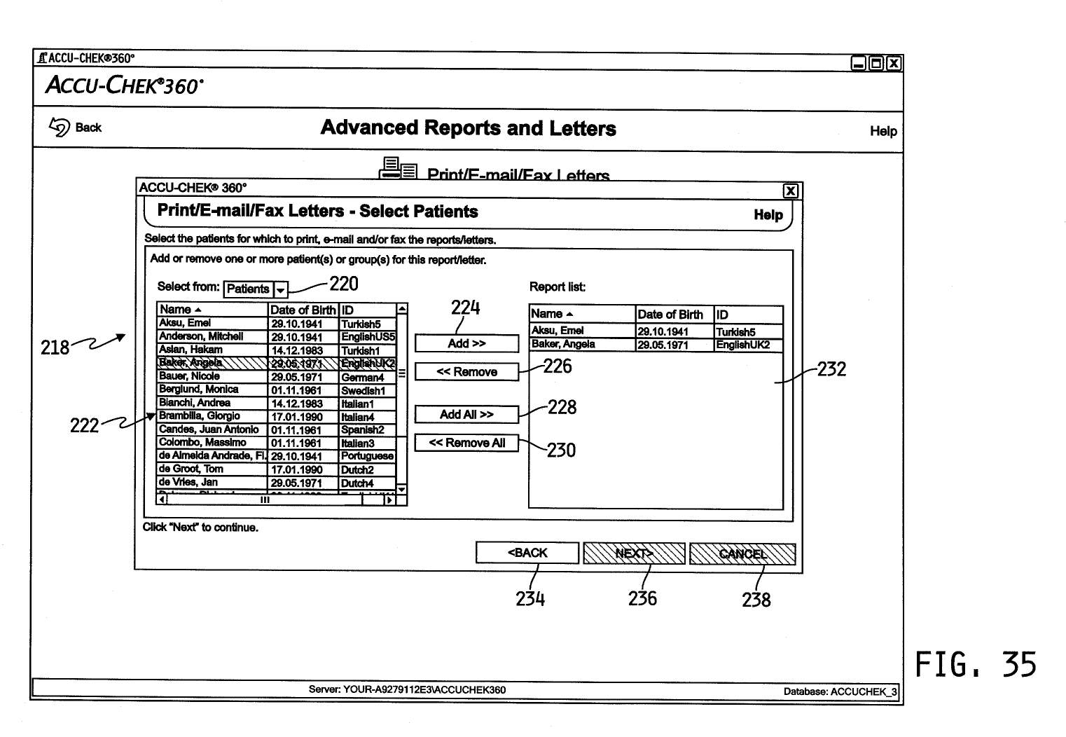

Return again to FIG. 2, selecting “print/e-mail/fax letters” icon 16 displays a “select patients” screen 218 (FIG. 34). “Select patients” screen 218 includes a drop down menu 220 that allows the user to display either a list of individual patients or a list of patient groups in field 222. “Select patients” screen 218 further includes “add” icon 224, “remove” icon 226, “add all” icon 228 and “remove all” icon 230. Screen 218 further includes an included patient field 232, a “back” icon 234, a “next” icon 236 and a “cancel” icon 238. To add a patient or group to included patient field 232, the user highlights the desired patient name and selects “add” icon 224 (FIG. 35). This causes the patient's name to be displayed in included patient field 232. As shown in FIG. 35, two patients have been selected. If the “groups” option had been selected from drop down menu 220, the selected patient groups would be included in field 232.

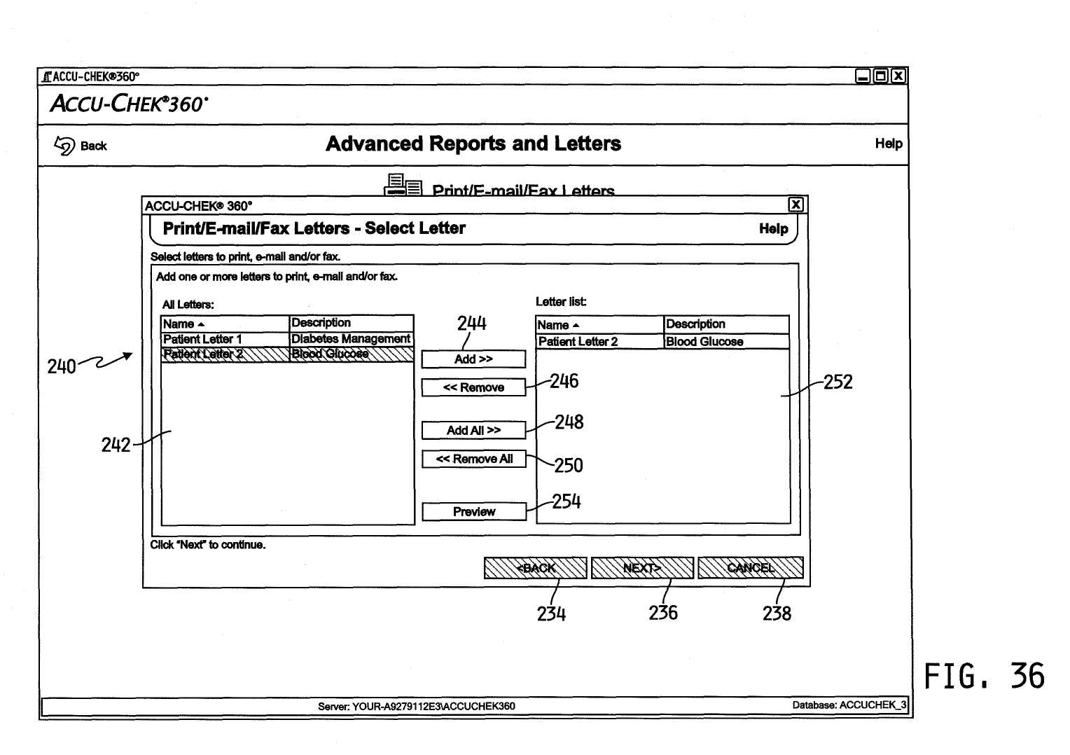

Once the user has populated field 232 as desired, he or she selects “next” icon 236 to display “select letter” screen 240 (FIG. 36). Screen 240 includes a listing of the available letters in field 242, “add” icon 244, “remove” icon 246, “add all” icon 248 and “remove all” icon 250. Screen 240 further includes an included letters field 252. To add a letter to field 252, the user highlights the letter in field 242 and selects “add” icon 244. Icons 246-250 are utilized to remove added letters from field 252 or to add and remove all letters to or from field 252 in the same manner as described above. Icons 234 and 236 are used to navigate between the various screens. Note that “select letter” screen 240 further includes a “preview” icon 254 that allows the user to preview the letter to be generated in a manner similar to that described above.

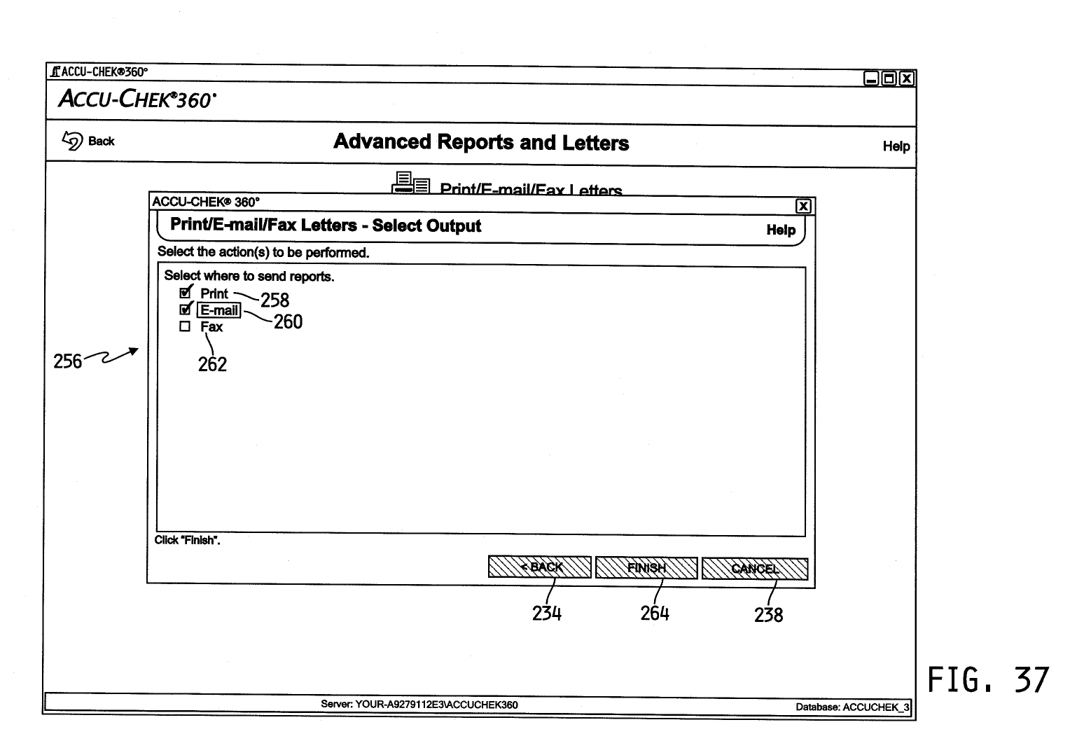

After the user has populated field 252, he or she selects “next” icon 236 to display “select output” screen 256 (FIG. 37). “Select output” screen 256 includes a print option 258, an e-mail option 260 and a fax option 262. Note that options for printing, e-mailing and faxing are shown only as examples. Other embodiments of the invention could utilize additional or other output devices, such as text messaging sent to a cellular phone, output to a web page or other means of communication. Note also that in other embodiments of the invention, the user can be provided with a language selection screen or drop down menu (not shown) at a desired time during the process to allow the user to select the output language for the letters. In this manner, a user who speaks one language, such as English, can generate letters to a patient who speaks another language, such as Spanish. Different languages can be selected for different patients or patient groups.

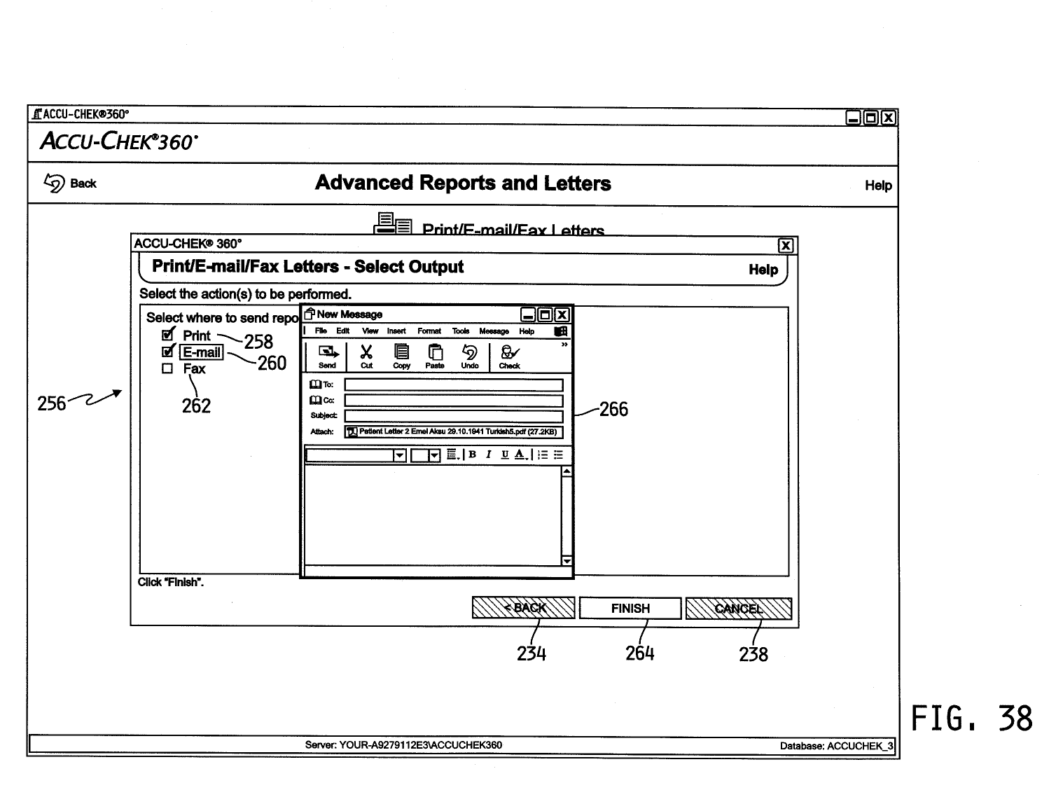

In the example shown in FIG. 37, print option 258 and e-mail option 260 have been selected. Once the desired options are selected, selecting “finish” icon 264 begins the letter output process. For example, selecting icon 264 will cause the system to retrieve from the database the information required to complete the selected letter templates for each patient or group. For example, the system will retrieve patient names, blood glucose readings or other information defined by the template. The selected letters for the selected patients will then print to a previously selected default printer. Alternatively, the system could be configured to display a printer menu so that a different printer could be selected. Similarly, selecting “finish” icon 264 will display a blank e-mail message 266 with the previously selected patient letter or letters attached (FIG. 38). The user can then input the recipient's address and a message before sending the e-mail. In the example shown in FIG. 37, had fax option 262 also been selected, selecting “finish” icon 264 would activate the fax drivers to transmit the selected letters.

Note that selecting “finish” icon 264 causes the system to output the letters in all of the selected output formats but that the sequence in which this occurs is not relevant. For example, e-mail message 266 shown in FIG. 38 could be displayed prior to the various print options discussed above.

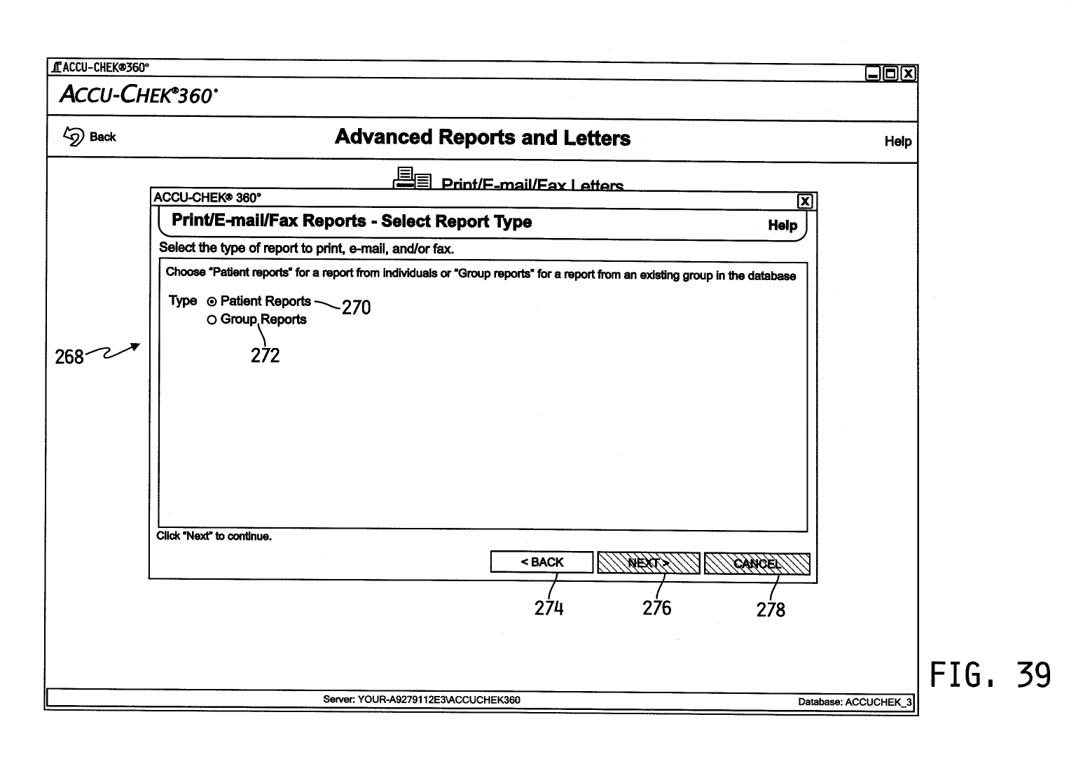

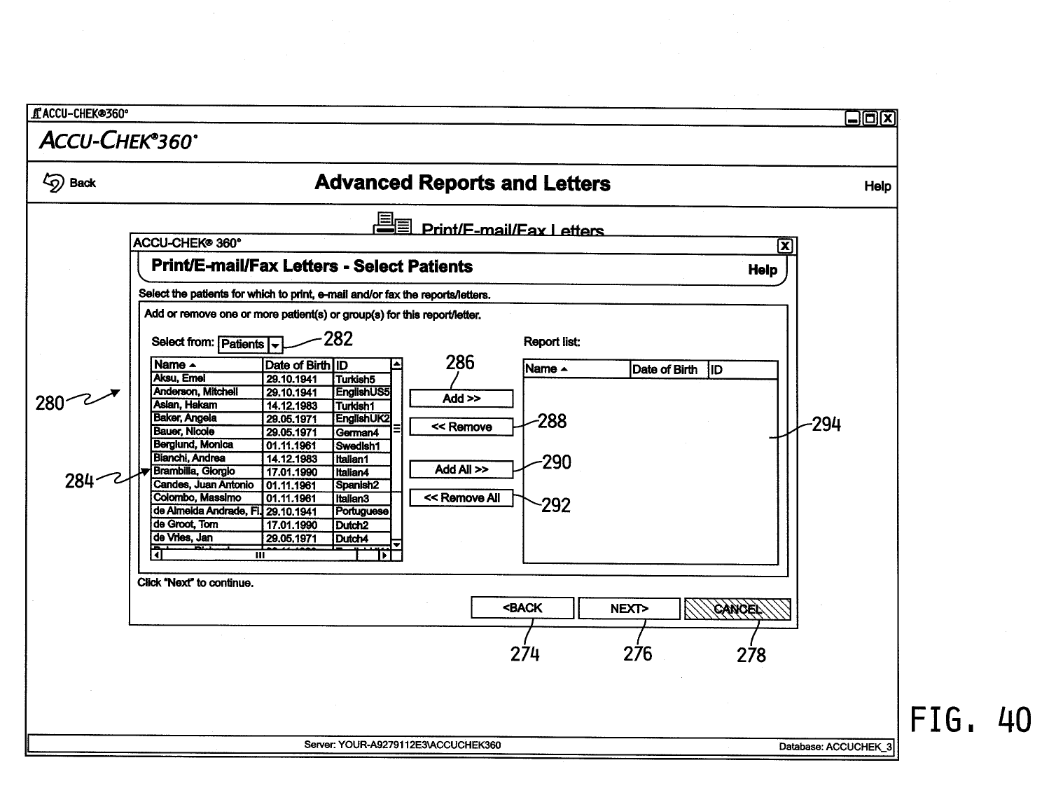

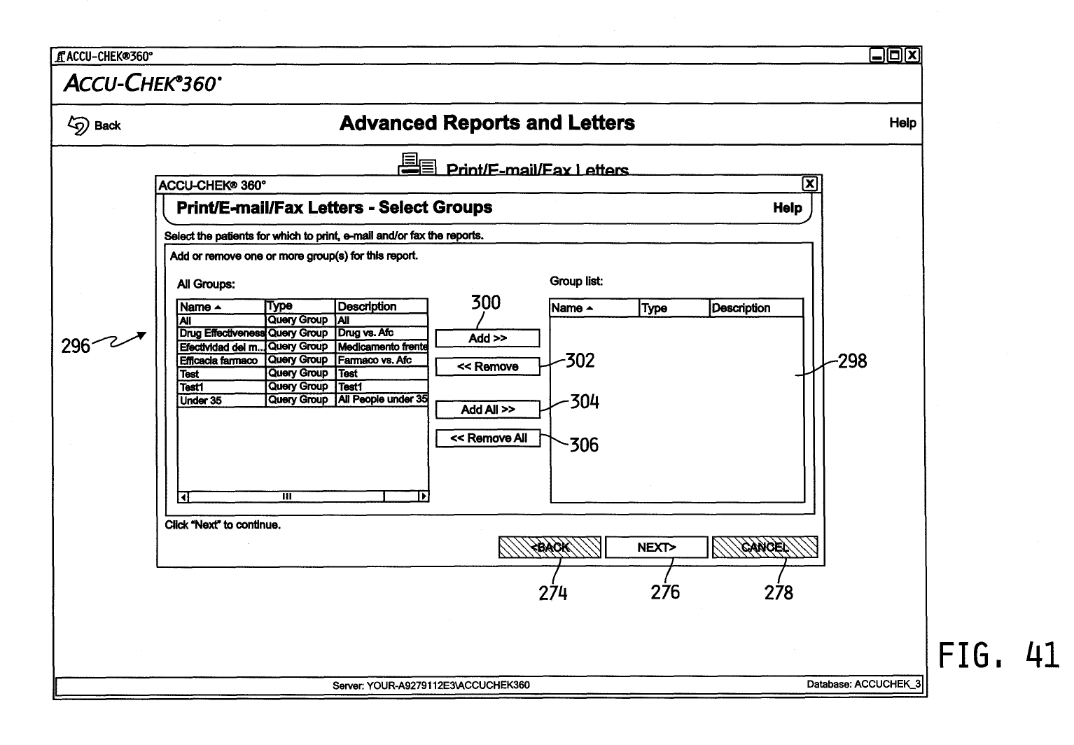

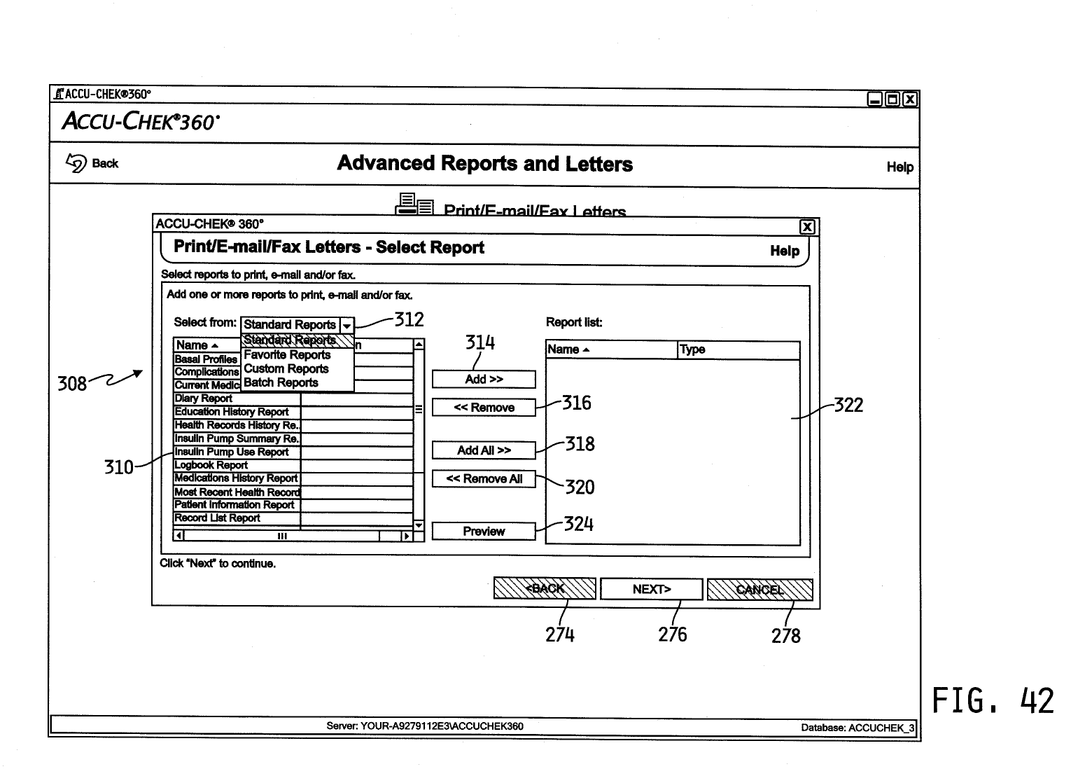

Returning again to FIG. 2, selecting “print/e-mail/fax” icon 18 displays a “select report type” screen 268 (FIG. 39). Screen 268 allows the user to select a patient report option 270 or a group report option 272. Selecting patient report option 270 and “next” icon 276 displays a “select patients” screen 280 as shown in FIG. 40. Note that although patient report option 270 was selected, drop down menu 282 also includes a “group reports” category (not shown) which would cause a listing of the patient groups to be displayed in field 284 as opposed to the patient listing as shown in FIG. 40. Icons 286, 288, 290 and 292 are used to add and remove patients from field 294 in the same manner as described above. Note also that selecting group reports option 272 in FIG. 39 displays “select groups” screen 296 that allows the user to populate included group field 298 using icons 300, 302, 304 and 306 (FIG. 41).

After the desired patients or groups have been selected, selecting “next” icon 276 displays a “select reports” screen 308. “Select reports” screen 308 includes a report list field 310, the contents of which are dictated by the options selected from drop down menu 312. Icons 314, 316, 318 and 320 are used to populate included report field 322 in the same manner as previously discussed. Screen 308 also includes a “preview” icon 324 for previewing the selected reports. Once field 322 has been populated, selecting “next” icon 276 causes a select output screen identical to that shown in FIG. 37 to be displayed, except that the screen bears the heading “print/e-mail/fax reports—select output.” The reports are then outputted in the same manner as described above in conjunction with the letters output.

While this invention has been described as having an exemplary design, the present invention may be further modified within the spirit and scope of this disclosure. For example, the system software can be run on any processing device with sufficient memory and other system requirements, such as a cellular phone, PDA, blood glucose meter or other device. Although the system has been described for use in connection with the treatment of diabetes, it can also be used in connection with other medical conditions. Furthermore, the various types of reports, letters, graphs and content are shown merely for purposes of illustration. Other reports, letters, graphs and content could also be used. It should further be noted that use of the term “graph” in this description is intended to cover any type of graphical display of information, such as histograms, pie charts, line graphs, bar charts, etc. Similarly, what is described as a report in the discussion above could be considered a letter and what is described as letter could be considered a report. Accordingly, these terms can be considered interchangeable and the software described above could combine the custom report building functionality with the custom letter building functionality. The same is true of the print/e-mail/fax functionalities. Thus, this application is intended to cover any variations, uses, or adaptations of the invention using its general principles. Further, this application is intended to cover such departures from the present disclosure as come within known or customary practice in the art to which this invention pertains.

What is claimed is:

1. A method of preparing a report template, including the steps of:
storing a plurality of report templates in a database;
selecting a first report template and a second report template from the plurality of report templates; and
storing the first and second report templates in the database as a third report template.

2. The method according to claim 1, further including the steps of selecting a fourth report template from the plurality of report templates and storing the third report template and the fourth report template in the database as a fifth report template.

3. The method according to claim 1, wherein the first report template includes a parameter and further including the step of changing the parameter of the first report template before storing the third report template.

4. The method according to claim 3, wherein the parameter is the time period covered by the report template.

5. The method according to claim 1, further including the step of naming the third report template.

6. The method according to claim 1, wherein the plurality of report templates stored in the database are grouped by report type.

7. The method according to claim 6, wherein reports for individuals is one of the report types.

8. The method according to claim 6, wherein reports for groups of individuals is one of the report types.

9. The method according to claim 6, wherein the report templates in at least one of the report type groups are further grouped by report category.

10. The method according to claim 1, further including the step of populating at least one of the first and the second report templates with medical information relating to an individual.

11. The method according to claim 10, wherein the medical information includes data relating to diabetes management.

12. The method according to claim 1, further including the step of previewing at least one of the first and the second report templates on a display.

13. The method according to claim 1, wherein the first report template include a graph.

14. A system for preparing a report template, including:
a database;
a plurality of report templates stored in the database;
means for selecting a first report template and a second report template from the plurality of report templates; and
means for storing the first and second report templates in the database as a third report template.

15. The system according to claim 14, further including means for editing the report templates stored in the database.

16. The system according to claim 14, further including means for assigning a name to the third template.

17. The system according to claim 14, further including means for creating a new report template.

18. The system according to claim 14, wherein the database includes medical information for populating at least one of the plurality of report templates.

19. The system according to claim 18, wherein the medical information includes data relating to diabetes management.

20. The system according to claim 14, further including means for outputting the third report template.
